(19) United States
(12) Patent Application Publication
(10) Pub. No.: US 2018/0130151 A1
(43) Pub. Date: May 10, 2018

(54) METHOD AND SYSTEM FOR IMPROVING AIRLINE PASSENGER PRODUCTIVITY AND TRAVEL ENJOYMENT USING CONNECTED INFORMATION NETWORKS

(71) Applicant: Plane Connected, LLC, Lakeway, TX (US)

(72) Inventor: Brian D. Kucic, Lakeway, TX (US)

(21) Appl. No.: 15/637,216

(22) Filed: Jun. 29, 2017

Related U.S. Application Data
(60) Provisional application No. 62/356,352, filed on Jun. 29, 2016.

(51) Int. Cl. G06Q 50/14; G06Q 20/36; G06Q 30/06; G06F 17/30

(52) U.S. Cl. CPC G06Q 50/14; G06Q 20/36; G06Q 50/01; G06F 17/30867; G06F 17/3087; G06Q 30/0641

(57) ABSTRACT

Method and system for improving airline passenger productivity and travel enjoyment using connected information networks acting as a closed loop system that each party interacts with. Users can see the list of people travelling today or in future and can send surprise gifts to them. An end user using PC decides to buy another user an in-flight item such as a drink. The payment would be in the second user's wallet as a credit balance for the amount that the first user transacted. A user can add text, voice or video his/her message with the credits. The second user gets a notification of the credit that was added to his/her PC wallet. As this is a closed loop the flight attendant would accept a code or an otp from the send user from the system that has been the recipient of the credit.

### CROSS REFERENCE TO RELATED APPLICATIONS

This application further claims the benefit of the U.S. Provisional Patent Application No. 62/356,352, filed Jun. 29, 2016, of which is hereby expressly incorporated by reference in its entirety.

### FIELD OF THE INVENTION

The present disclosure relates to optimization of time and effort spent during airline travel and, more particularly to a method and system for improving airline passenger productivity and travel enjoyment using connected information networks.

### BACKGROUND OF THE INVENTION

As airlines seek to improve the onboard passenger experience, so too must they identify new ways to increase revenues, as well as benefit passengers both on and off the plane. Ranging from in-flight retailing to inventive commercial partnerships, airlines seek to significantly raise their in-flight ancillary revenues.

Some known approaches for increasing in-flight ancillary revenues may include allowing passengers to place orders for food, beverages and various other items via the embedded in-flight entertainment screens. Self-service seatback shopping has now emerged has a practical way to encourage spend among passengers. But, this mode of communication and commerce fails to benefit from the multi-faceted communications that could be available.

Thomson Airways, another airline, has equipped cabin crew with iPads as part of a trial for introducing fully-fledged onboard destination-based activities—such as excursions and theme park tickets. These duties, however, fall under the remit of flight attendants, whose skill sets and responsibilities continue to expand. Onboard connectivity is providing opportunities for cabin crew to become fully-fledged concierges, with airlines able to earn commission from onboard sales of third-party products. However, this kind of offering may be unduly complex and distracting from the safety functions that are paramount for flight attendants.

For many, online shopping is now the norm, and airlines have an opportunity to tap into a widespread commercial trend to bolster their own revenues. The retailer has a captive audience being pushed towards their website and the airline has an opportunity to claim a percentage of a sale that it has helped to drive. Surely a win-win for all involved.

Smartwatch-based sales may also provide ancillary revenues for airlines. For example, Monarch Airlines allow passengers to place orders from their seat via the MPlayer Apple Watch app.

Bearing some similarities to the way airlines can drive self-service ordering and payment via the seatback IFE screens, wearable technology provides another significant retail opportunity. With smartwatch uptake on the rise and Apple Pay gaining traction as a practical contactless payment option, smartwatch-based ordering and payment has emerged as another viable way of driving in-flight sales.

Some carriers, such as Delta Air Lines, have equipped flight attendants with mobile devices as part of wider efforts to drive onboard ancillary sales. Airlines often talk about the potential of Big Data, but actually making use of it to enhance efficiency and increase revenues is easier said than done. Tracking passenger habits to personalize the passenger experience can also extend to personalizing the sales approach. A crew member could let them know about the offer, or it could be “pushed” to the passenger's seatback screen, tablet, smartphone or smartwatch. Airports are starting to invest in delivering real-time, relevant content to passengers while they are in the terminal, and with the number of connected aircraft on the rise, airlines could make use of a similar approach to drive their own revenues upwards.

All of these approaches, while representing advancements in airline revenue fail to consider the richness of passenger relationships, affinities, desires, and ways to connect with one another during travel.

There is the need within the travel industry, particularly in the airline industry for maximizing the time that the traveler travels on an airplane during business hours or otherwise.

### BRIEF SUMMARY OF THE INVENTION

The disclosed subject matter provides for a method and system for improving airline passenger productivity and travel enjoyment using connected information networks.

In light of the above, the present disclosure provides a method and system for acting as a closed loop system that each party interacts with. Users can see the list of people travelling today or in future and can send surprise gifts to them. An end user using PC decides to buy another user an in-flight item such as a drink. The First end user selects from a menu and then proceed to make a credit payment towards the 2nd end user (the recipient) in the system. The payment would be in the 2nd user's wallet as a credit balance for the amount that the first user transacted. If the order for the surprise gift fails, the system will show a relevant reason to the respective user and give them option to retry. User Can add Text, Voice or Video his/her message with the credits. The second user gets a notification of the credit that was added to his/her PC wallet.

The credit can be used at any time, but would be limited to places that offer the PC service. On a flight the end user may use their credit to order beverages of any kind or a snack or meal or merchandise.

The flight attendant would also utilize the system via a mobile application to interact with the 2nd user's transaction. As this is a closed loop the flight attendant would accept a code or an otp from the second user from the system that has been the recipient of the credit. The flight attendant 105 would, utilizing the code or otp from the 2nd user, apply the credit towards a purchase.

In the back end the system the clearing house mechanism would credit the agreed amount to the recipient that is providing the goods.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGUREs and examples are not meant to limit the scope of the present subject matter to a single embodiment, but other embodiments are possible by way of interchange of some or all of the described or illustrated elements and, further, wherein:

FIG. 1 shows an overall flowchart for the Plane Nice features and functions of the disclosed subject matter

FIG. 2A shows a login screen applicable to the system of the present disclosure;

FIG. 2B shows a profile screen associated with a mobile device employing the system of the present disclosure

FIG. 2C provides a screen applicable to the synchronize travel information functions of the system of the present disclosure;

FIG. 2D shows the functions screen associated with a mobile device for adding a new email identifier;

FIG. 2E shows are user interface applicable to the travel sing functions of the present disclosure;

FIGS. 2F and 2G illustrate contacts associated with the system of the present disclosure;

FIGS. 2H, 2I and 2J show screens whereby a user may indicate particular interests for populating the user profile in the system of the present disclosure;

FIGS. 2K, 2L, 2M, and 2N illustrate various contacts that may be associated and using the Plane Nice features of the present disclosure;

FIGS. 2O, 2P, 2Q and 2R illustrate certain functions of the present disclosure relating to the ability to search for a particular profile and profile of other is associated with the system of the present disclosure;

FIG. 2S illustrates the results of the search that may identify positive results for a particular filter, such as the instance of searching for individuals from California;

FIG. 2T illustrates an aspect of the system of the present closure for associating with the service LinkedIn for contacting individuals in associating with the system of the present disclosure;

FIG. 2U illustrates a login screen that is enabled by use of LinkedIn and connecting with the LinkedIn application;

FIGS. 2V, 2W, 2X, 2Y, and 2Z illustrate certain aspects of purchasing benefits or gifts using the Plane Nice features of the present disclosure;

FIG. 2AA shows an aspect of the play nice features of the present disclosure whereby a recipient can decline a gift or in-flight drink and, instead, donate to a particular charity;

FIG. 2AB illustrates certain aspects of the plane nice feature of the present disclosure for checking out our paying for a benefit or drink for a particular user from a remote purchaser;

FIG. 2AC illustrates a notification screen where buy a used purchaser can receive notification that the transaction that the purchaser site was successfully completed;

FIGS. 2AD and 2AE show the ability of the system of the present disclosure to record and attach to a notification a particular video that will notify the recipient of the benefit being offered by a purchaser;

FIGS. 2AF, 2AG, 2AH, and 2AI illustrate Plane Layover functions of the system of the present disclosure;

FIGS. 2AJ, 2AK, 2AL and 2AM show certain aspects of Meet Ups functions associated with the Plane Layover features of the present disclosure;

FIGS. 2AN, 2AO and 2AP illustrate certain aspects of menu selection associated with the Plane Layover functions of the present disclosure;

FIGS. 2AQ, 2AR, 2AS, and 2AT illustrate certain aspects associated with a Meet Ups functions of the present disclosure;

FIGS. 2AU, 2AV, 2AW, 2AX, and 2AY illustrate certain screens applicable to the Mutual Locations aspect of the Play Layover features in the present disclosure;

FIGS. 2AZ, 2BA, and 2BB illustrate certain notifications relating to Meet Up functions within the Plane Layover features of the present disclosure;

FIGS. 2BC, 2BD, 2BE illustrate certain aspects of the My Flight information functions of the system of the present disclosure;

FIGS. 2BF, 2BG, 2BH, 2BI, 2BJ, 2BK, 2BL, and 2BM illustrate further aspects of the notifications features for the system as a present disclosure;

FIGS. 2BN, 2BO, 2BP, and 2BQ illustrate notification and communications relating to messaging functions associated with the system of the present disclosure;

FIGS. 2BR, 2BS, and 2BT relating to further integration of the system of the present disclosure with social media platform; and

FIGS. 2BU, and 2BS illustrate airline and interface screens applicable to the system of the present disclosure.

FIG. 3 illustrates the association of the Plane Connect App witching the context of a user's profile.

FIG. 4 shows an exemplary system within computing environment for implementing the present disclosure;

FIG. 5 provides a block diagram for illustrating portable multifunction devices 200 with touch-sensitive displays 212 in accordance with some embodiments for the presently disclosed method and system;

FIG. 6 illustrates a portable multifunction device having a touch screen in accordance with some embodiments;

FIG. 7 illustrates the order checkout process features and functions of the disclosed subject matter;

FIG. 8 shows the registration process features and functions of the disclosed subject matter;

FIG. 9 illustrates the login process associated with an administrator for administrating features and functions of the disclosed subject matter;

FIG. 10 shows an overall flow chart for creating a campaign whereby a vendor or advertiser may interface with the system;

FIG. 11 shows a real-time example of a chart for providing additional campaign information from a partner or other vendor;

FIGS. 12 and 13 show how an airport vendor may interface the system of a present disclosure;

FIG. 14 illustrates third-party workflow using third-party API's;

FIG. 15 illustrates how various databases integrate with the system at the present disclosure;

FIG. 16 shows processes applicable to the Plane Layover and Plane Nice aspects of the present disclosure;

FIG. 17 shows how the present system identifies the location of a particular user on an airplane;

FIG. 18 illustrates the functions of the present system whereby a user populates a user profile;

FIG. 19 illustrates the Plane Alumni features of the present disclosure;

FIG. 20 describes the functions associated with a Plane Connected Wallet feature for use in the system or the present disclosure;

FIG. 21 illustrates the Plane Conference features of the present disclosure;

FIGS. 22 and 23 show the features of the present discussing associated with the function of a Plane Layover;

FIG. 24 illustrates how the present disclosure may provide Plane Layover functions for those individuals who may not be users of the system of the present disclosure;

FIGS. 25 and 26 show the Plane Destination features of the presently disclosed system;

FIG. 27 shows the Plane Feedback functions of the present disclosure;

FIG. 28 illustrates the Plane Hometown features of the present disclosure;

FIG. 29 illustrates the Plane Kids function of the present disclosure;

FIG. 30 provides a functional flowchart for the Plane Nice features of the present disclosure;

FIG. 31 shows how a purchase transaction may occur within the systems of the present disclosure;

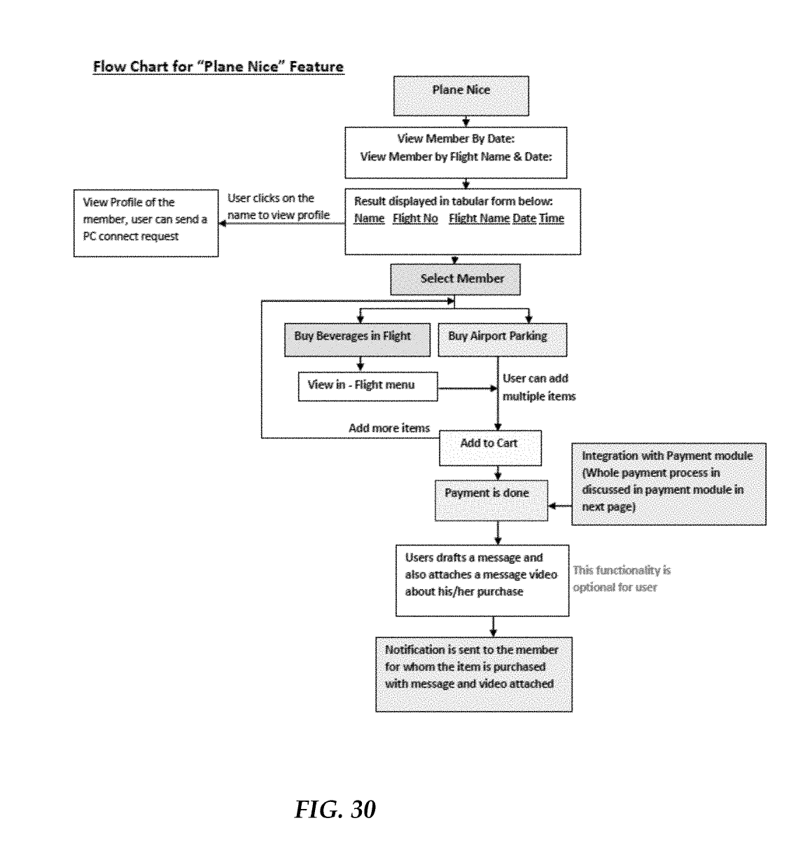

FIG. 30 illustrates the Plane Relocating features of the present disclosure;

FIGS. 33 and 34 show the Plane Single functions of the present disclosure;

FIG. 35 illustrates the Plane Sports features of the present disclosure;

FIG. 36 illustrates the Plane Tired function of the system of the present disclosure;

FIG. 37 illustrates how a user may login to the system using an email connection;

FIG. 38 illustrates the functions of the system of the present disclosure provides in the event that the user desires to import contacts from LinkedIn or another source;

FIG. 39 illustrates the sign-up functions of the system of the present disclosure and how a user may sign up using social media or email or other applications for becoming a user of the presently disclosed method and system;

FIG. 40 illustrates the functions of the system of the present disclosure for enabling a vendor to participate or present to a purchaser or user the functions and benefits and features of the present system;

FIG. 41 shows how the method and system of the present disclosure use social media for the purpose of establishing an advertising campaign or otherwise benefiting the user;

FIG. 42 illustrates the functions of the system of the present disclosure provides in the event that the user forgets his password

### DETAILED DESCRIPTION OF ILLUSTRATIVE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

Although the method and system for improving airline passenger productivity and travel enjoyment using connected information networks here disclosed have been described in detail herein with reference to the illustrative embodiments, it should be understood that the description is by way of example only and is not to be construed in a limiting sense. It is to be further understood, therefore, that numerous changes in the details of the embodiments of this disclosed process and additional embodiments of this method and system for a method and system for improving airline passenger productivity and travel enjoyment using connected information networks will be apparent to, and may be made by, persons of ordinary skill in the art having reference to this description. It is contemplated that all such changes and additional embodiments are within the spirit and true scope of this disclosed method and system as claimed below.

One aspect of the present disclosures the ability to chat to adjust the window of time where in the system functions for identifying contacts in a user's network that may also be laid over in the airport. This will provide for their ability for connecting with such individuals and allow for the optimization of the time that both the user and the contact would have in the airport, if they desire. So, for example, in the event that a 30 minute later because over becomes a four-hour layover, the system of the present disclosure would allow the user the ability to expand the time during the layover or where in the layover contact base is determined. This would give the ability, potentially, to reach out to additional contacts that might not otherwise be contacted during such a previously considered shorter layover.

The system of the present disclosure provides the ability to do additional business with contacts who may be in the users network. At the same time, for the purpose of the user enjoyment, the system make provide the ability for the user to connect with friends and contacts he hasn't seen in a while, because they would be unexpectedly in the airport and identified as a member of the users contact base. This would give the user to make contacts unexpectedly and beneficially between the contact and the user.

Another aspect of the present disclosure is the ability to use the application as a means for updating a user's salesforce.com database. When using the system of the present disclosure it is easy to provide contact information or information relating to a contact made into the system. Automatically, with a push of a button, the system provides the ability to connect that information directly to the salesforce.com contact information for that particular contact. This may be particularly helpful in the scenario where on an airplane or during a time when a there isn't Wi-Fi or the ability to use a personal computer, the present disclosure provides the ability come on a mobile device. The ability to immediately import a notification to a contacts file in Saleforce.com file permits the user to stay up to the minute and tracking contacts and relating information relating to a contact the company for which the individual purchase the works.

In other countries, it is becoming generally excepted that laptop computers may not be brought into the airline cabin for safety reasons and otherwise. For example, there is some concern that laptops themselves may have explosives or otherwise be threatening to the cabin. As such, airlines or progressively prohibiting the use of laptop computers within the cabin. Then, the only device for connection maybe the handheld Mobile device. In such a scenario, the application of the present disclosure has particular value. Because it has the ability to enter great the user with the salesforce.com and other communication platforms that would otherwise be applied or access through a notebook computer. Here the system provides the ability to make that connection directly as LinkedIn and SalesForce.com applications would be integrated directly with present platform.

Another aspect of the present disclosures that it provides a built-in flight information. This information can be timely and useful and may not be otherwise accessible via other platforms or otherwise to the user. The particular flight information in connection information that the present disclosure provides can be very valuable to users as they are trying to make tight connections across large airports in otherwise.

Another aspect of the present disclosures the ability to identify include for the user information relating to rental cars, air and hotel information, and other travel information that may be important as the user tries to work his way through the commercial aviation system for getting to a particular destination or in route to a particular destination.

Yet further aspect of the present disclosure is the ability to receive and engage in particular data analytics functions. So, for example, in the event that a user should land in an airport wherein during the next 24 hours a particular event, such as a sporting event, may occur, there is the ability to reach out to the user and inform the end-user of such event. So, for example, if a user arrives in Atlanta and the data analytics function herein provided identifies the user as a Texas Longhorns fan. If next day is a network of that between the University of Texas in the University of Georgia, for example the information would provide to the user purchasing opportunities and other benefits that may relate to events that are going on in the venue where the user may have recently landed. This may include, for example discounts on meals and drinks and other types of things, as well as discounts there are new purchasing opportunities for some of the retail establishments are located within the airport. These data analytics functions would provide new purchasing and some new sales opportunities for the user as well as the vendors and businesses in us associated with the particular airport or in association with the commercial airlines. Other benefits, I may further include, gift cards are other benefits or gifts that would arise and be particularly useful for the purchaser that would enable it for their enjoyment and optimization of the travel experience all as a result of the system or the present disclosure.

The conferencing function of the present disclosure allows the user to identify passengers on the airplane who may also be attending a particular conference to which the user may be traveling. In such event, the ability is provided herein such that the user would have the ability to connect with it, if we decide, such conference attendees for the mutual benefit of the attendees as well as the user.

Another aspect of the present disclosure is the ability to enhance a recruiting function. For example, another aspect of the present disclosure is the ability to connect a recruiter where passengers on flights where it is not uncommon for both potential employees and potential employers to be riding. In such an instance, a recruiter may have the ability to identify those individuals on an airplane who could fit or be appropriate for a position for which the user I have knowledge of the opening. Say, for example a recruiter from indeed.com has the ability to identify those passengers with technical background so that might be appropriate for particular jobs. In such cases, the system of the present disclosure would get the ability to connect with between the recruiter in the individuals to schedule a brief meeting following deplaning at the airport. Such a meeting would provide perhaps in advance indication of a match between the position and a potential hire.

FIGURE to a shows a login page that may appear on a mobile device for use in an airline cabin by a passenger. There are numbers ways that a person may log into the system of the present disclosure these include use of a Facebook account, a Google plus account, an email account, or Twitter account, or other electronic means for interfacing with the application of the present disclosure. The present disclosure permits the user to log in and import the users linked in account information, including all of the contacts appearing on the linked in account for the user.

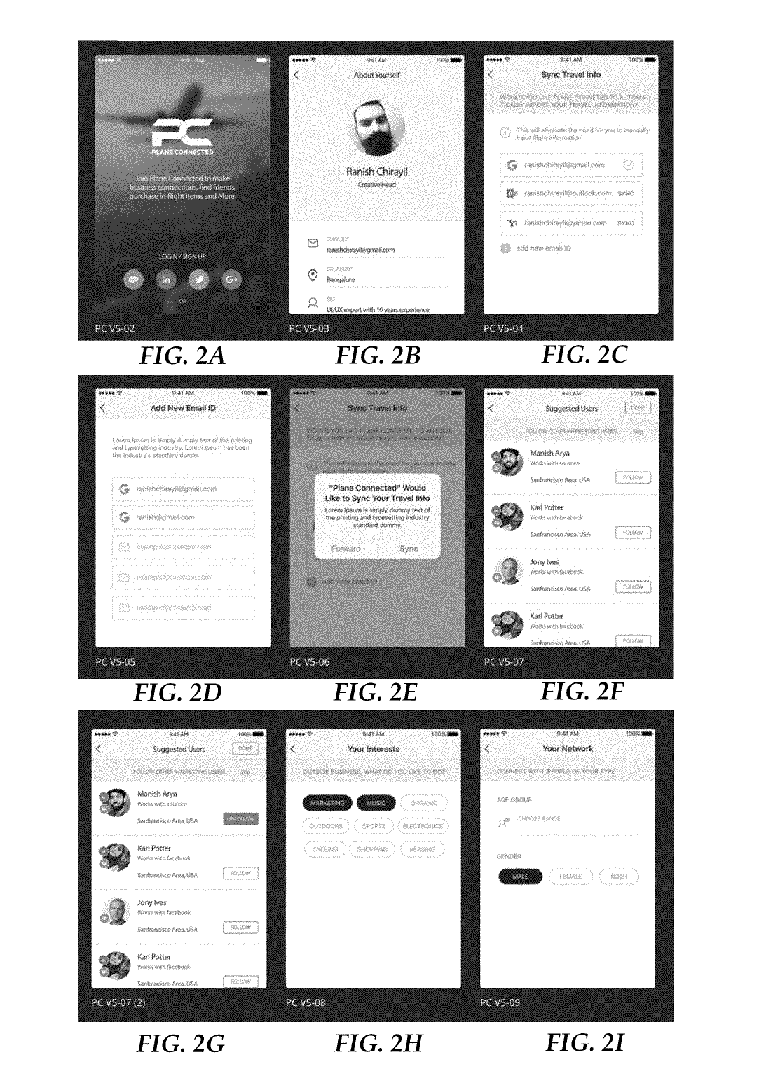

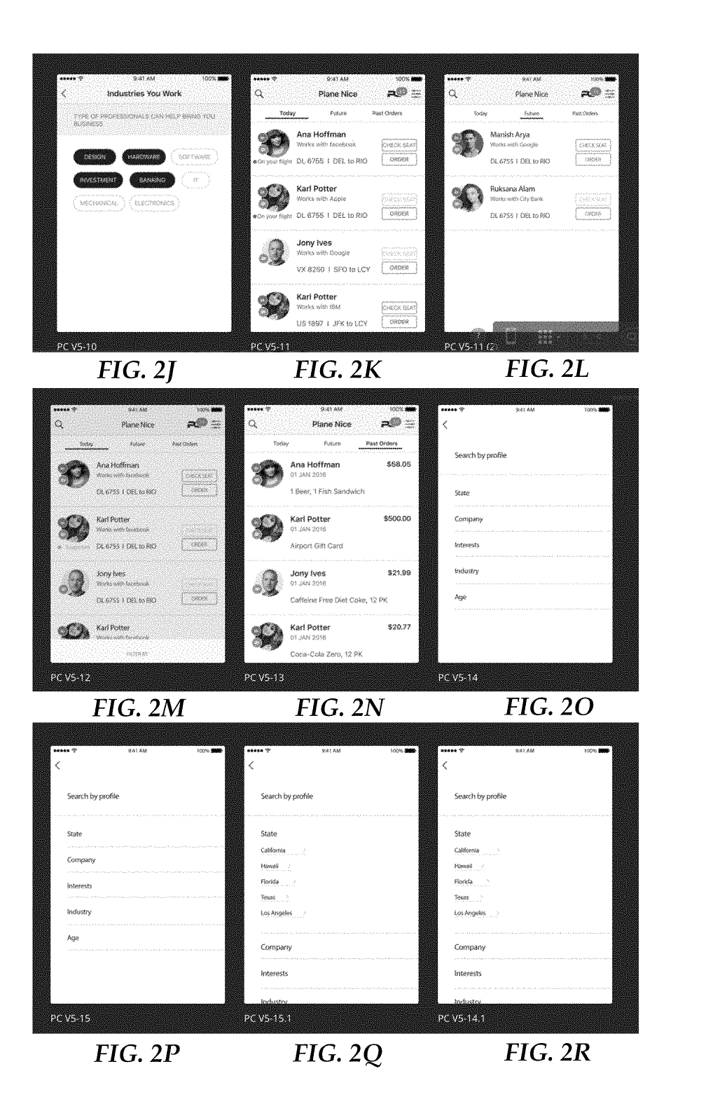

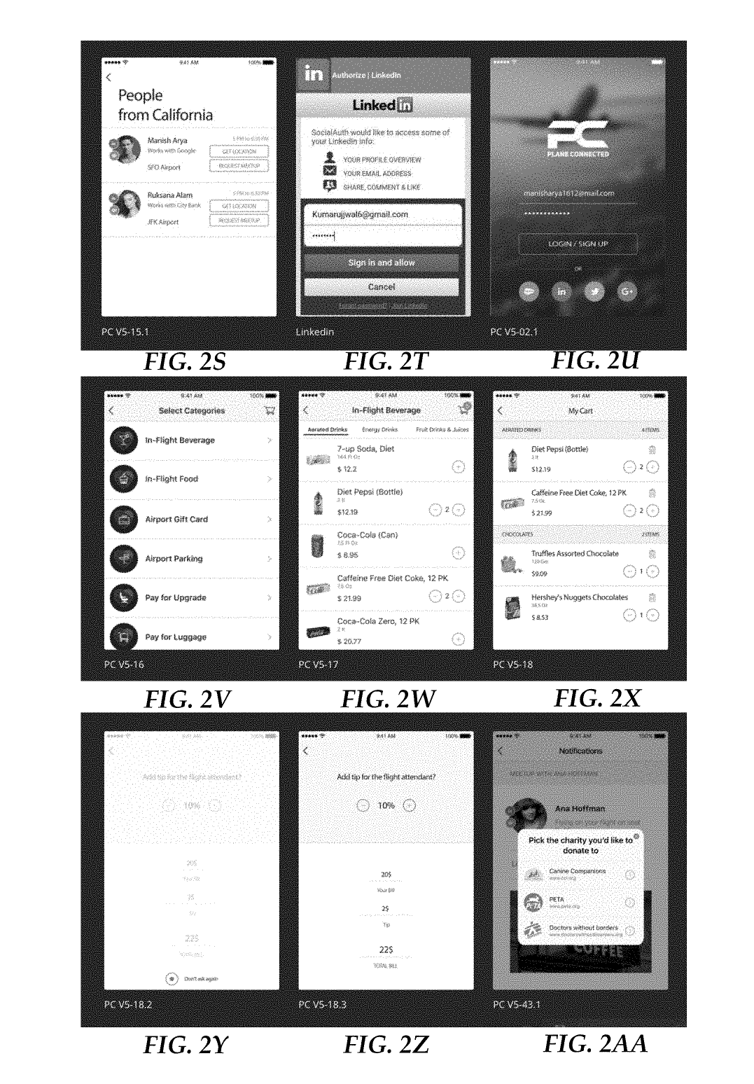

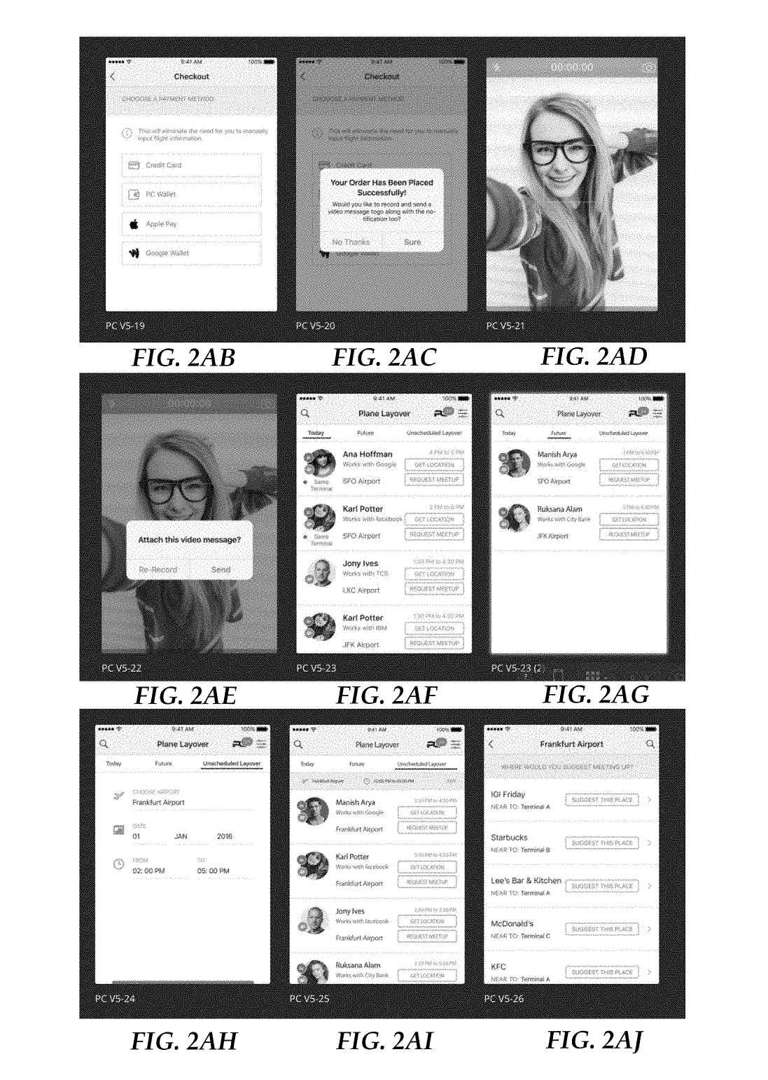

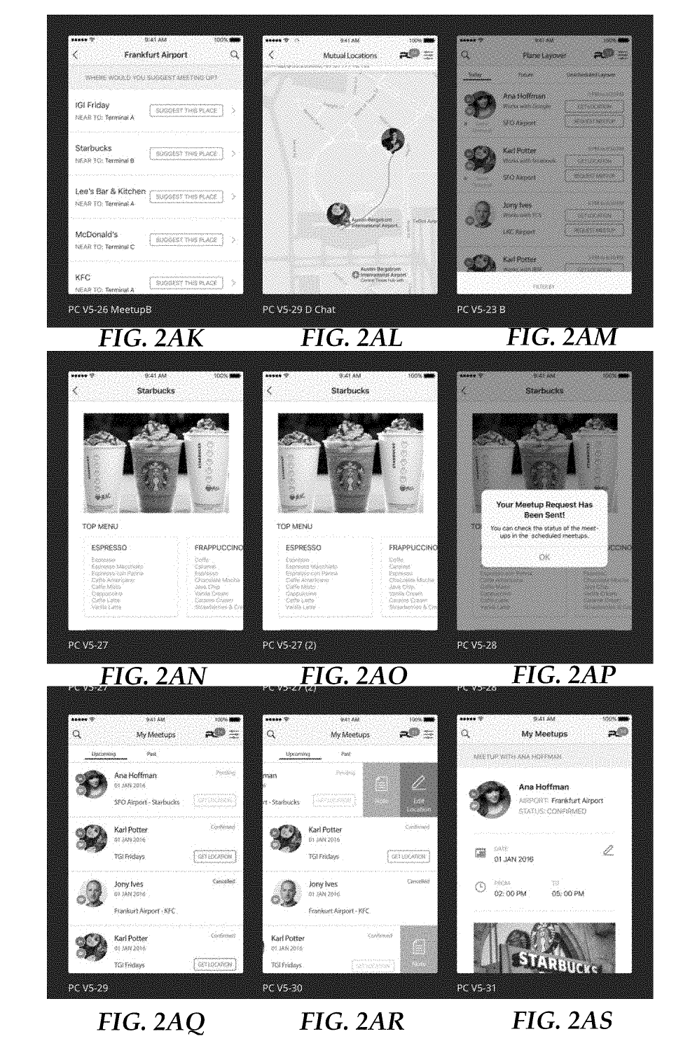

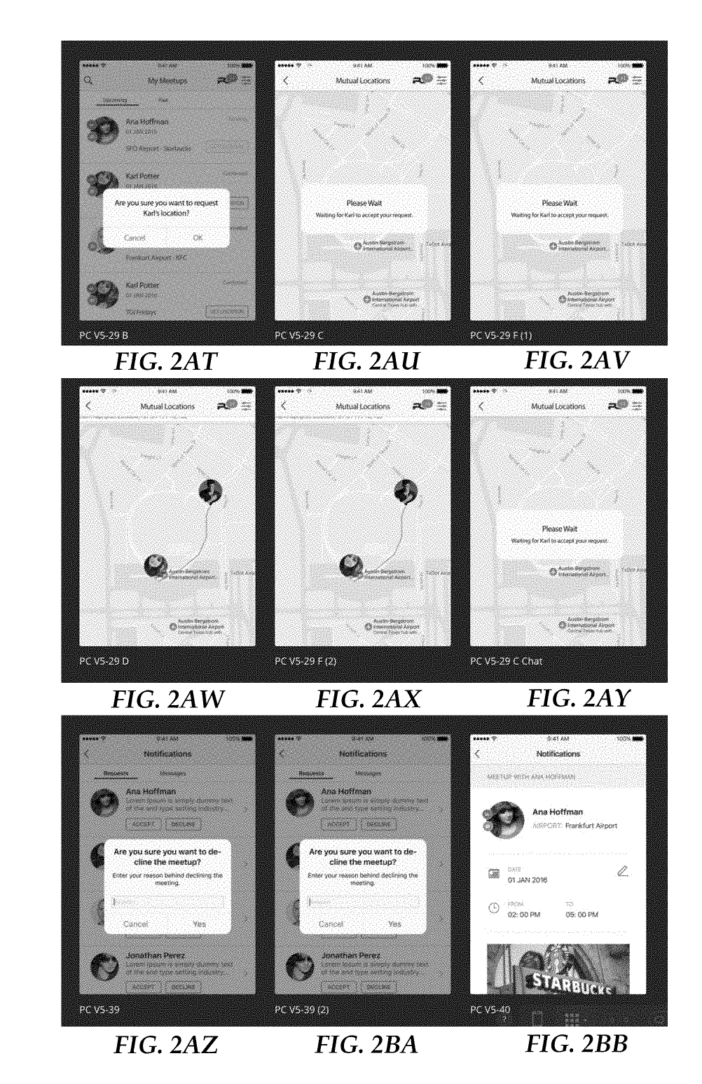

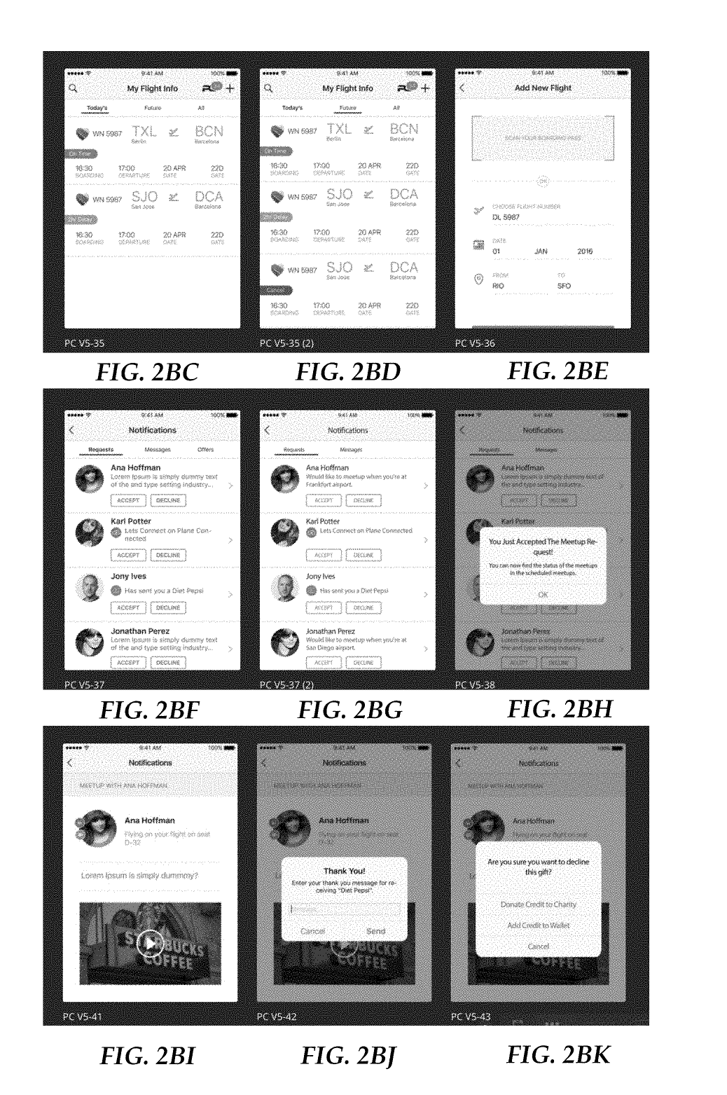

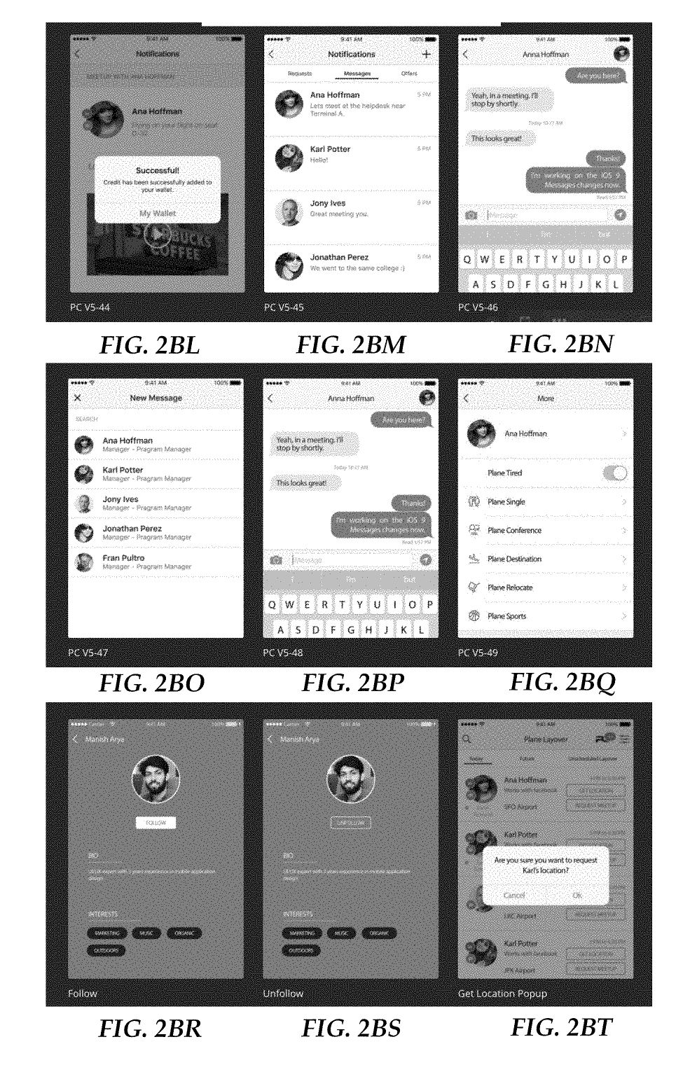

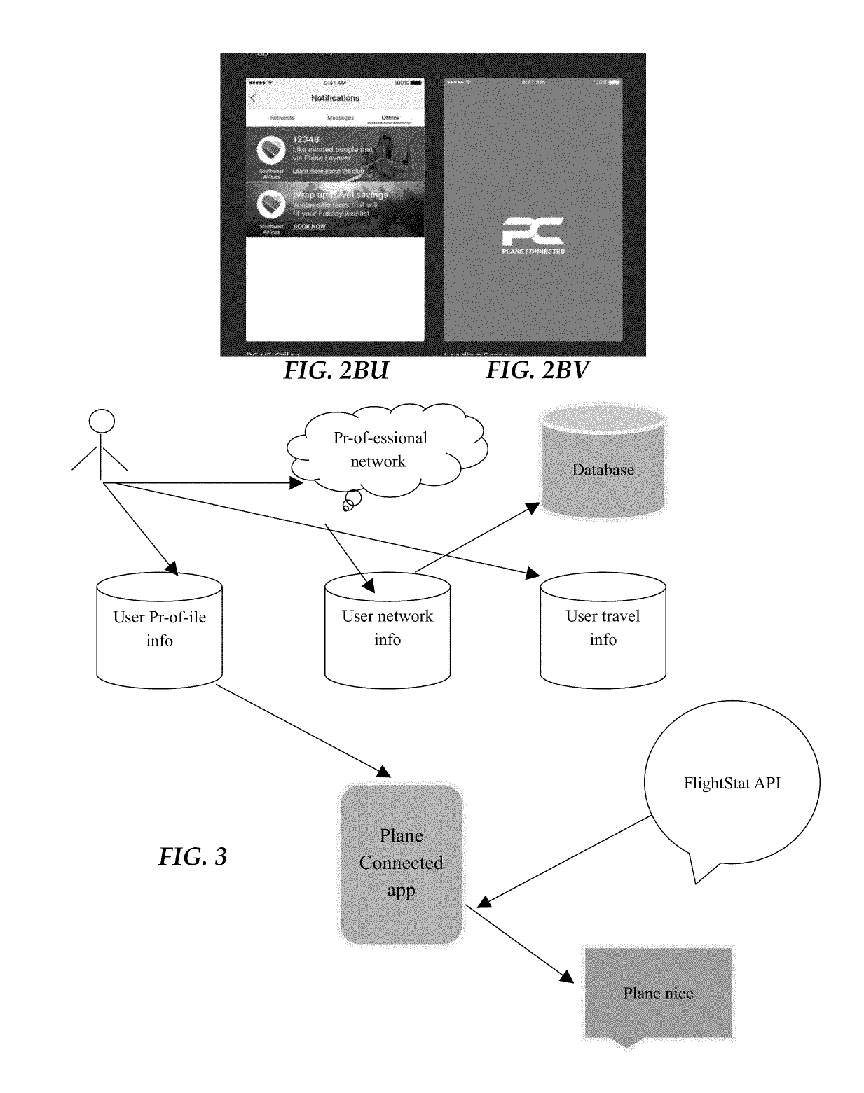

FIG. 2B shows an example of a user profile that may be used within the System of the present disclosure. FIG. 2C shows how a user may sync the travel information applicable to the trip during which the user uses the system of the present disclosure. On the other hand, the user may not only sync the information but also provide email to the system that would provide the details concerning the particular trip. This information may be provided to the system of the present disclosure, such as when a user may reserve a flight on an air on an airline website and simply add the email for connecting the flight information to the presently disclose system.

Each airline that uses the system has the ability to provide a default airline page for the user interface.

The system of the present disclosure defaults into the Plane Nice sequence of functions in the earliest stages of operation. In the Plane Nice application, all of the user's contacts in the user's network will be provided to the present system. This will include those persons in the user's network that may be flying on the airplane or in the airport for that particular day.

As a user employs the system, the plane nice contacts continue to grow and become part of the integrated system of the present disclosure.

Adding a user via LinkedIn data entry or contact information occurs when the user request of the LinkedIn contact with her the link and contact would desire or would agree to be added to the plane nice contact. The system of the present disclosure provides information to the use of all of the user's contacts who may be flying on that particular day that the user also is flying.

The system of the present disclosure provides the ability to identify to the user where the users contacts may be on the airplane. This is a function that the contacts would opt into and the user it's self would also often too.

The system of the present disclosure provides the ability to gift or award a recipient with a drink or other complementary bonus. The sender of the gift a complementary bonus or a drink, does not need to be on the airplane in order to gift or award the drink or other benefit to the recipient. As a function of the present disclosure, there is now the ability to provide additional sales for an airline where the person gifting the recipient or awarding the recipient does not need to be on the airplane but can be elsewhere and at the same time recognize the recipient and have the recipient enjoy the benefit of the recognition from the gift provider or purchaser of the particular award.

As a result of the process of the present disclosure, there is the ability to provide in real time a transaction that otherwise may not occur without the system of the present disclosure. This system, therefore, opens the passenger base of a particular airplane to the awards and to the benefits of being recognized by someone who is not on the airplane this may include, for example, upgrade to first class, drinks, gifts from the onboard duty-free shop and other benefits that otherwise the only the airline passenger would have the ability to transact.

The results of the present disclosure, therefore, is to release the airlines in-flight revenue from being down to only the passengers in the cabin. Instead, anyone who wants to transact via the system of the present disclosure may purchase items for the benefit of particular recipients on the airplane.

The computing infrastructure for the system of the present disclosure, may take a variety of forms. How does essence, this would include a network connected computer or set of computers that may reside on the airplane. FIG. 3, therefore shows the functions of a particular computer that may be appropriate for implementing certain aspects of the presently just close system.

If a purchaser decides to gift recipient with a drink or other benefit, the purchaser may record a video and transmit the video to the recipient the video within play for the recipient we're by the gift or can the purchaser can send a message thanking the recipient for a particular job well done overachievement in that video also would also inform the recipient that the particular drink or other benefit is coming his way. At the same time, the flight attendant would be informed by the system of the present disclosure that the purchaser had made the purchase that the recipient is in a particular seat on the airline and provide particulars about the particular gift or benefit that the purchaser is providing to the passenger.

Another aspect of the present disclosure is the ability to program or pay in advance for benefits her gifts that a recipient may receive wanted airline or airplane ride in the future. Thus, for example, if a purchaser desires to present to a recipient a particular recognition or mail her gift, by use of the present disclosure the system of the present disclosure is the ability to identify who the particular passengers are when they are traveling with the gifts or a communicate to the airline so that the airline has the ability to acquire the particular gifts for giving to the passenger at the time prescribed by the particular flight. This may even include, for example an upgrade from coach to first class, which would be a welcome surprise from the purchaser to the recipient.

Another aspect of the present disclosure is the ability to keep records of transactions for financial accounting it for tax reasons that may be beneficial for using the system as a means for marketing a client development. This may further increase revenues for airlines as the use and knowledge of the system becomes more pervasive.

Another aspect of the system of the present disclosure is a function because here in described as “Plane Layover.” Thus, in the event that a user has contacts in the plane connected network, who may be laid over in a particular airport, the system of the present disclosure has the ability to have dinner at five those individuals and perhaps even identify a place where they may be meet up with the particular individual in the event of such a layover.

Thus, when an unexpected layover occurs and the time happens to provide and meeting ability for a user of the present disclosure and a person in the user's network, the system would provide the ability for the two to meet. Such an unexpected meeting may be highly attractive and beneficial for both of the user of the system and the person with whom the user meet. The system of the present disclosure has numerous functions relating to meet ups that are describe both in the flow charts as well as the user interface screens here in provided.

Another aspect of the Plane Nice functions includes the situation when an order is placed for a purchase. It's such event, that a purchaser buys a drink or other benefit for recipient and the recipient does not have the ability to except or otherwise declines to except the particular drink or other benefit, the system provides the ability to use that benefit as the recipient may require or request. Thus, a recipient user of the system has the ability to perceive receive a notification of a drink or other benefit being purchased for the recipient. The system of the present disclosure provides the recipient in the ability to decline the benefit from the purchaser and at the same time A charity or other recipient for the benefit. It's such event, the recipient has the ability to be recognized for the contribution to the charity. In the event that a recipient directs a benefit to a charity, there may be particular rules regarding the attribution are sharing or accountability for the benefit. However, the system of the present disclosure accommodates this type of allocation making sure that all of the necessary rules regarding donations or and taxes relating thereto or appropriately dressed.

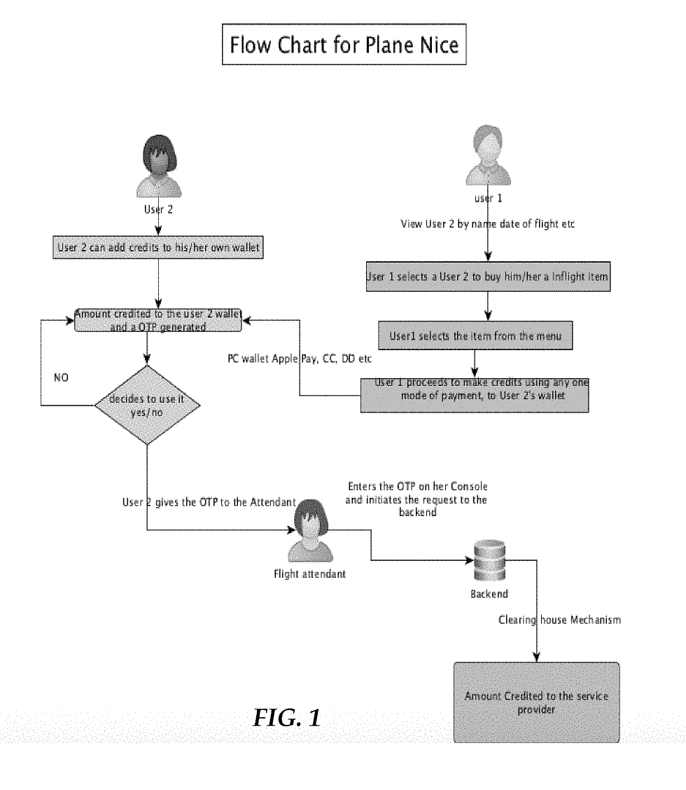

FIG. 1 shows an overall flowchart for the Plane Nice features and functions of the disclosed subject matter to illustrate the novel steps and instructions that an embodiment may perform for communicating and transacting between a passenger, a purchaser, and a flight attendant on a passenger airline for improving the enjoyment and optimizing the business efficiency of time spent traveling. Exemplary electronic devices and computer processors and networks for performing the functions of the present disclosure appear herein at FIGS. 3 through 6. The features and steps appearing in FIG. 1 are included in this paragraph to the full extent as though expressly written here.

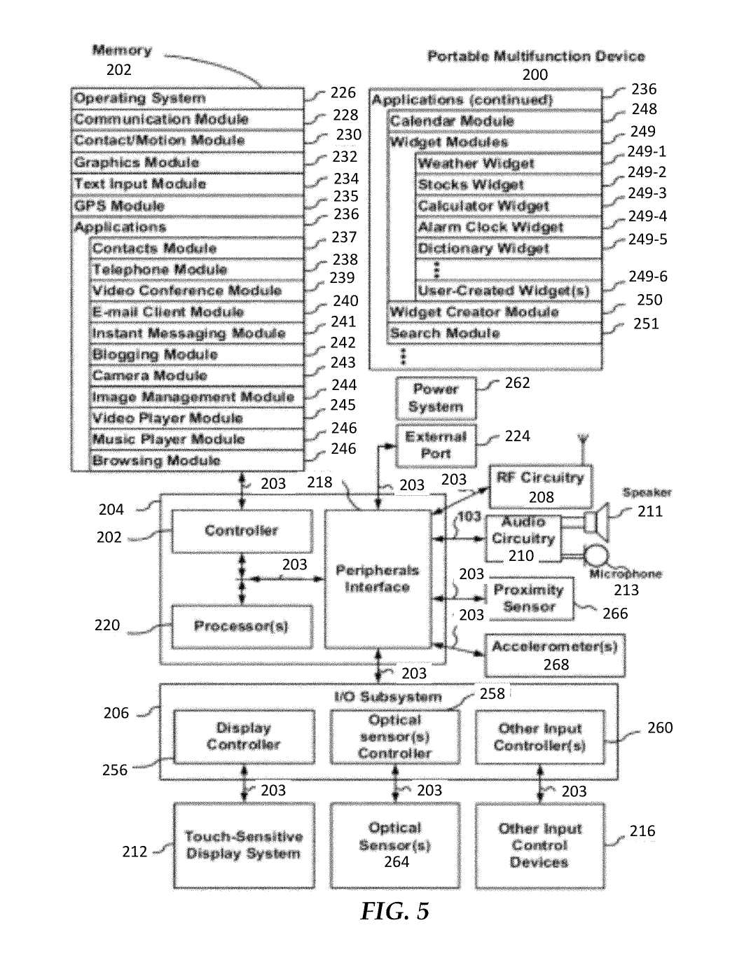

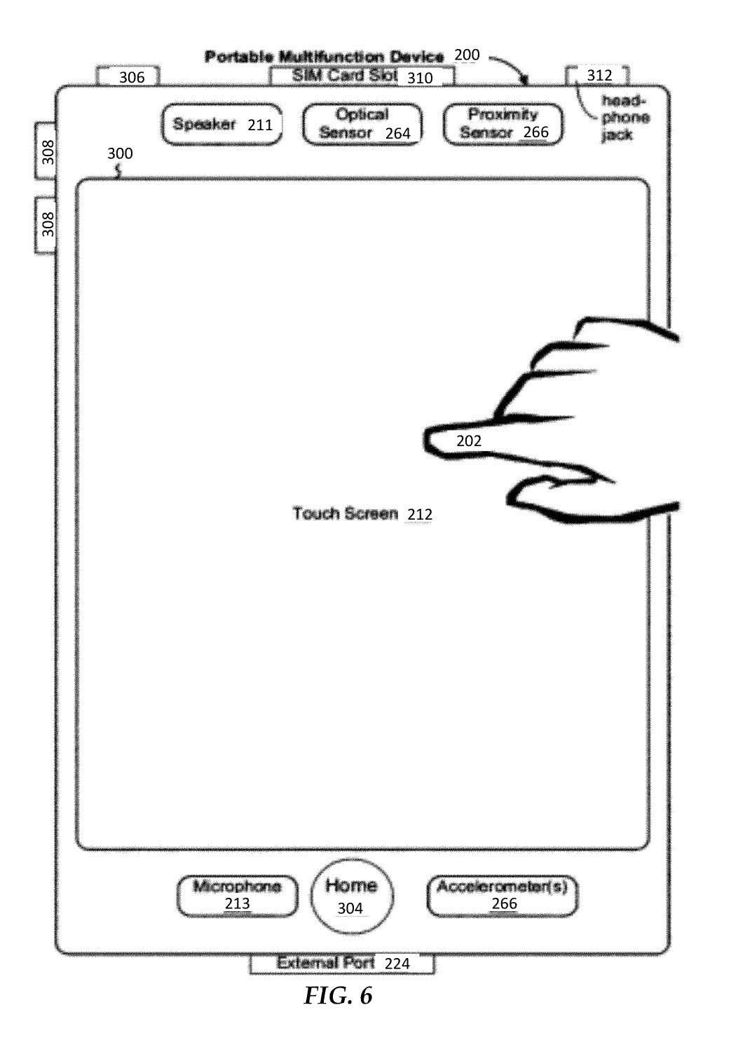

The method and system of the present disclosure make use of one or more mobile device such as described below in FIGS. 5 and 6. In the use of such a device, the present method and system provide user interface screens and mobile device functions as herein presented. The computer processes and program logic for performing the data storage and computer instruction execution and communication will be appreciated by a person having ordinary skill in the present technology upon understanding the processes herein described. Accordingly, FIG. 2A shows a login screen applicable to the system of the present disclosure;

FIG. 2B shows a profile screen associated with a mobile device employing the system of the present disclosure

FIG. 2C provides a screen applicable to the synchronize travel information functions of the system of the present disclosure;

FIG. 2D shows the functions screen associated with a mobile device application of the present disclosure for adding a new email identifier;

FIG. 2E shows are user interface applicable to the travel sing functions of the present disclosure;

FIGS. 2F and 2G illustrate contacts associated with the system of the present closure using Facebook and salesforce.com links for users that may integrate with the system of the present disclosure;

FIG. 2H, 2I and 2J show screens whereby a user may indicate particular interests for populating the user profile in the system of the present disclosure;

FIGS. 2K, 2L, 2M, and 2N illustrate various contacts that may be associated and using the Plane Nice features of the present disclosure;

FIGS. 2O, 2P, 2Q and 2R illustrate certain functions of the present disclosure relating to the ability to search for a particular profile and profile of other is associated with the system of the present disclosure;

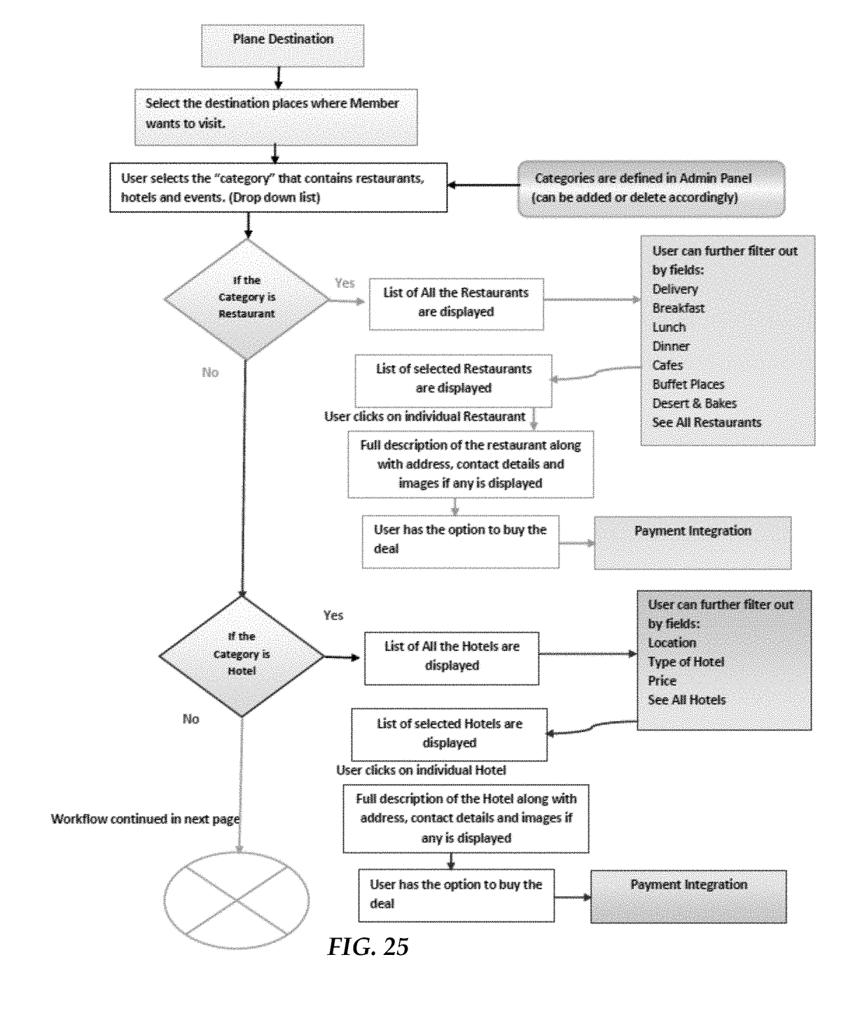

FIG. 25 illustrates the results of the search that may identify positive results for a particular filter, such as the instance of searching for individuals from California;

FIG. 2T illustrates an aspect of the system of the present closure for associating with the service LinkedIn for contacting individuals in associating with the system of the present disclosure;

FIG. 2U illustrates a login screen that is enabled by use of LinkedIn and connecting with the LinkedIn application;

FIGS. 2V, 2W, 2X, 2Y, and 2Z illustrate certain aspects of purchasing benefits or gifts using the Plane Nice features of the present disclosure;

FIG. 2AA shows an aspect of the play nice features of the present disclosure whereby a recipient can decline a gift or in-flight drink and, instead, donate to a particular charity;

FIG. 2AB illustrates certain aspects of the plane nice feature of the present disclosure for checking out our paying for a benefit or drink for a particular user from a remote purchaser;

FIG. 2AC illustrates a notification screen where buy a used purchaser can receive notification that the transaction that the purchaser site was successfully completed;

FIGS. 2AD and 2AE show the ability of the system of the present disclosure to record and attach to a notification a particular video that will notify the recipient of the benefit being offered by a purchaser;

FIGS. 2AF, 2AG, 2AH, and 2AI illustrate Plane Layover functions of the system of the present disclosure;

FIGS. 2AJ, 2AK, 2AL and 2AM show certain aspects of Meet Ups functions associated with the Plane Layover features of the present disclosure;

FIGS. 2AN, 2AO and 2AP illustrate certain aspects of menu selection associated with the Plane Layover functions of the present disclosure;

FIGS. 2AQ, 2AR, 2AS, and 2AT illustrate certain aspects associated with a Meet Ups functions of the present disclosure;

FIGS. 2AU, 2AV, 2AW, 2AX, and 2AY illustrate certain screens applicable to the Mutual Locations aspect of the Play Layover features in the present disclosure;

FIGS. 2AZ, 2BA, and 2BB illustrate certain notifications relating to Meet Up functions within the Plane Layover features of the present disclosure;

FIGS. 2BC, 2BD, 2BE illustrate certain aspects of the My Flight information functions of the system of the present disclosure;

FIGS. 2BF, 2BG, 2BH, 2BI, 2BJ, 2BK,2BL, and 2BM illustrate further aspects of the notifications features for the system as a present disclosure;

FIGS. 2BN, 2BO, 2BP, and 2BQ illustrate notification and communications relating to messaging functions associated with the system of the present disclosure;

FIGS. 2BR, 2BS, and 2BT relating to further integration of the system of the present disclosure with social media platform; and

FIGS. 2BU, and 2BS illustrate airline and interface screens applicable to the system of the present disclosure.

FIG. 3 illustrates the association of the Plane Connect App within the context of a user's profile. Within the architecture and features introduced in FIGS. 1 through 2BV, above, the system performs the functions here described.

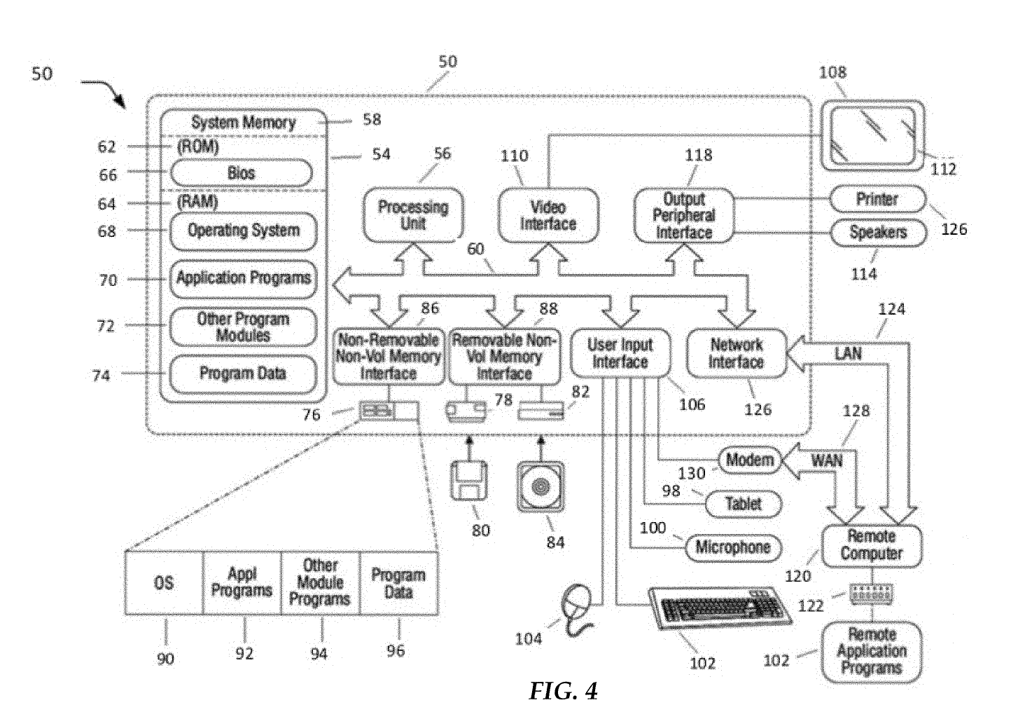

The data capture, analysis, and use of the method and system of the present disclosure require the use of a computing system associated with a commercial or passenger airplane wireless network system. Thus, with reference to FIG. 4, an exemplary system within computing environment 50 for implementing the disclosure includes a general-purpose computing device in the form of computing system 52, commercially available from, for example, Intel, IBM, AMD, Apple, Motorola, Cyrix, etc. Components of computing system 54 may include, but are not limited to, processing unit 56, system memory 58, and system bus 60 that couples various system components including system memory 58 to processing unit 56. System bus 60 may be any of several types of bus structures including a memory bus or memory controller, a peripheral bus, or a local bus using any of a variety of bus architectures.

Computing system 52 typically includes a variety of computer readable media. Computer readable media can be any available media that can be accessed by computing system 52 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 52.

System memory 58 includes computer storage media in the form of volatile and/or nonvolatile memory such as read only memory (ROM) 62 and random access memory (RAM) 64. A basic input/output system (BIOS) 66, containing the basic routines that help to transfer information between elements within computing system 52, such as during start-up, is typically stored in ROM 62. RAM 64 typically contains data and/or program modules that are immediately accessible to and/or presently being operated on by processing unit 56. By way of example, and not limitation, operating system 68, application programs 70, other program modules 72, and program data 74 are shown.

Computing system 52 may also include other removable/non-removable, volatile/nonvolatile computer storage media. By way of example only, hard disk drive 76 that reads from or writes to non-removable, nonvolatile magnetic media, a magnetic disk drive 78 that reads from or writes to removable, nonvolatile magnetic disk 80, and an optical disk drive 82 that reads from or writes to removable, nonvolatile optical disk 84 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 76 is typically connected to the system bus 60 through a non-removable memory interface such as interface 86, and magnetic disk drive 78 and optical disk drive 82 are typically connected to the system bus 60 by a removable memory interface, such as interface 88.

The drives and their associated computer storage media, discussed above, provide storage of computer readable instructions, data structures, program modules and other data for computing system 52. For example, hard disk drive 76 is illustrated as storing operating system 90, application programs 92, other program modules 94 and program data 96. Note that these components can either be the same as or different from operating system 68, application programs 70, other program modules 72, and program data 74. Operating system 90, application programs 92, other program modules 94, and program data 96 are given different numbers here to illustrate that, at a minimum, they are different copies.

A user may enter commands and information into the computing system 52 through input devices such as tablet or electronic digitizer 98, microphone 100, keyboard 102, and pointing device 104, commonly referred to as a mouse, trackball, or touch pad. These and other input devices are often connected to the processing unit 56 through a user input interface 106 that is coupled to the system bus 60, but may be connected by other interface and bus structures, such as a parallel port, game port or a universal serial bus (USB).

Monitor 108 or other type of display device is also connected to the system bus 60 via an interface, such as a video interface 110. Monitor 108 may also be integrated with a touch-screen panel 112 or the like. Note that the monitor and/or touch screen panel can be physically coupled to a housing in which computing system 52 is incorporated, such as, for example, in a tablet-type personal computer or smart phone. In addition, computers such as computing system 52 may also include other peripheral output devices such as speakers 114 and printer 116, which may be connected through an output peripheral interface 118 or the like.

Computing system 52 may operate in a networked environment using logical connections to one or more remote computers, such as a remote computing system 120. The remote computing system 120 may be a personal computer (including, but not limited to, mobile electronic devices), a server, a router, a network PC, a peer device or other common network node, and typically includes many or all of the elements described above relative to computing system 52, although only a memory storage device 122 has been illustrated. The logical connections depicted include a local area network (LAN) 124 connecting through network interface 126 and a wide area network (WAN) 128 connecting via modem 130, but may also include other networks such as, for example, mobile telephone service networks. Such networking environments are commonplace in offices, enterprise-wide computer networks, intranets, mobile networks, and the Internet.

For example, in the present embodiment, computer system 52 may comprise the source machine from which data is being generated/transmitted and the remote computing system 120 may comprise the destination machine. Note however that source and destination machines need not be connected by a network or any other means, but instead, data may be transferred via any media capable of being written by the source platform and read by the destination platform or platforms.

In another example, in the present embodiment, remote computing system 120 may comprise the source machine from which data is being generated/transmitted and computer system 52 may comprise the destination machine.

In a further embodiment, in the present disclosure, computing system 52 may comprise both a source machine from which data is being generated/transmitted and a destination machine and remote computing system 120 may also comprise both a source machine from which data is being generated/transmitted and a destination machine.

Referring to FIG. 4, for the purposes of this disclosure, it will be appreciated that remote computer 120 may include any suitable term such as, but not limited to “device”, “processor based mobile device”, “mobile device”, “electronic device”, “processor based mobile electronic device”, “mobile electronic device”, “wireless electronic device”, or “location-capable wireless device,” including a smart phone or tablet computer.

The central processor operating pursuant to operating system software such as, but not limited to, Apple IOS®, Google Android® IBM OS/2®, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embodied directly in hardware, in a software module executed by a processor, or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

FIG. 5 provides a block diagram for illustrating portable multifunction devices 200 with touch-sensitive displays 212 in accordance with some embodiments for the presently disclosed method and system. The touch-sensitive display 212 is sometimes called a “touch screen” for convenience, and may also be known as or called a touch-sensitive display system. The device 200 may include a memory 202 (which may include one or more computer readable storage mediums), a memory controller 222, one or more processing units (CPU's) 220, a peripherals interface 218, RF/NFC circuitry 208, audio circuitry 210, a speaker 211, a microphone 213, an input/output (I/O) subsystem 206, other input or control devices 216, and an external port 224. The device 200 may include one or more optical sensors 264. These components may communicate over one or more communication buses or signal lines 203.

It should be appreciated that the device 200 is only one example of a portable multifunction device 200, and that the device 200 may have more or fewer components than shown, may combine two or more components, or a may have a different configuration or arrangement of the components. The various components shown in FIG. 5 may be implemented in hardware, software or a combination of both hardware and software, including one or more signal processing and/or application specific integrated circuits.

Memory 202 may include high-speed random access memory and may also include non-volatile memory, such as one or more magnetic disk storage devices, flash memory devices, or other non-volatile solid-state memory devices. Access to memory 202 by other components of the device 200, such as the CPU 220 and the peripherals interface 218, may be controlled by the memory controller 222.

The peripherals interface 218 couples the input and output peripherals of the device to the CPU 220 and memory 202. The one or more processors 220 run or execute various software programs and/or sets of instructions stored in memory 202 to perform various functions for the device 200 and to process data.

In some embodiments, the peripherals interface 218, the CPU 220, and the memory controller 222 may be implemented on a single chip, such as a chip 204. In some other embodiments, they may be implemented on separate chips.

The RF/NFC (radio frequency) circuitry 208 receives and sends RF/NFC signals, also called electromagnetic signals. The RF/NFC circuitry 208 converts electrical signals to/from electromagnetic signals and communicates with communications networks and other communications devices via the electromagnetic signals. The RF/NFC circuitry 208 may include well-known circuitry for performing these functions, including but not limited to an antenna system, an RF/NFC transceiver, one or more amplifiers, a tuner, one or more oscillators, a digital signal processor, a CODEC chipset, a subscriber identity module (SIM) card, memory, and so forth.

The RF/NFC circuitry 208 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS), and/or Short Message Service (SMS), or any other suitable communication protocol, including communication protocols not yet developed as of the filing date of this document.

The audio circuitry 210, the speaker 211, and the microphone 213 provide an audio interface between a user and the device 200. The audio circuitry 210 receives audio data from the peripherals interface 218, converts the audio data to an electrical signal, and transmits the electrical signal to the speaker 211. The speaker 211 converts the electrical signal to human-audible sound waves. The audio circuitry 210 also receives electrical signals converted by the microphone 213 from sound waves. The audio circuitry 210 converts the electrical signal to audio data and transmits the audio data to the peripherals interface 218 for processing. Audio data may be retrieved from and/or transmitted to memory 202 and/or the RF/NFC circuitry 208 by the peripherals interface 218. In some embodiments, the audio circuitry 210 also includes a headset jack (e.g. 212, FIG. 2). The headset jack provides an interface between the audio circuitry 210 and removable audio input/output peripherals, such as output-only headphones or a headset with both output (e.g., a headphone for one or both ears) and input (e.g., a microphone).

The I/O subsystem 206 couples input/output peripherals on the device 200, such as the touch screen 212 and other input/control devices 216, to the peripherals interface 218. The I/O subsystem 206 may include a display controller 256 and one or more input controllers 260 for other input or control devices. The one or more input controllers 260 receive/send electrical signals from/to other input or control devices 216. The other input/control devices 216 may include physical buttons (e.g., push buttons, rocker buttons, etc.), dials, slider switches, joysticks, click wheels, and so forth. In some alternate embodiments, input controller(s) 260 may be coupled to any (or none) of the following: a keyboard, infrared port, USB port, and a pointer device such as a mouse. The one or more buttons (e.g., 208, FIG. 5) may include an up/down button for volume control of the speaker 211 and/or the microphone 213. The one or more buttons may include a push button (e.g., 206, FIG. 2). A quick press of the push button may disengage a lock of the touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button (e.g., 206) may turn power to the device 200 on or off. The user may be able to customize a functionality of one or more of the buttons. The touch screen 212 is used to implement virtual or soft buttons and one or more soft keyboards.

The touch-sensitive touch screen 212 provides an input interface and an output interface between the device and a user. The display controller 256 receives and/or sends electrical signals from/to the touch screen 212. The touch screen 212 displays visual output to the user. The visual output may include graphics, text, icons, video, and any combination thereof (collectively termed “graphics”). In some embodiments, some or all of the visual output may correspond to user-interface objects, further details of which are described below.

A touch screen 212 has a touch-sensitive surface, sensor or set of sensors that accepts input from the user based on haptic and/or tactile contact. The touch screen 212 and the display controller 256 (along with any associated modules and/or sets of instructions in memory 202) detect contact (and any movement or breaking of the contact) on the touch screen 212 and converts the detected contact into interaction with user-interface objects (e.g., one or more soft keys, icons, web pages or images) that are displayed on the touch screen. In an exemplary embodiment, a point of contact between a touch screen 212 and the user corresponds to a finger of the user.

The touch screen 212 may use type of LCD (liquid crystal display) technology, LED (light emitting diode) or LPD (light emitting polymer display) technology, although other display technologies may be used in other embodiments. The touch screen 212 and the display controller 256 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 212.

A touch-sensitive display in some embodiments of the touch screen 212 may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in their entirety. However, a touch screen 212 displays visual output from the portable device 200, whereas touch sensitive tablets do not provide visual output.

A touch-sensitive display in some embodiments of the touch screen 212 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 212 may have a resolution in excess of 100 dpi. In an exemplary embodiment, the touch screen has a resolution of approximately 160 dpi. The user may contact the touch screen 212 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the device 200 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 212 or an extension of the touch-sensitive surface formed by the touch screen.

The device 200 also includes a power system 262 for powering the various components. The power system 262 may include a power management system, one or more power sources (e.g., battery, alternating current (AC), a recharging system, a power failure detection circuit, a power converter or inverter, a power status indicator (e.g., a light-emitting diode (LED)) and any other components associated with the generation, management and distribution of power in portable devices.

The device 200 may also include one or more optical sensors 264. FIG. 5 shows an optical sensor coupled to an optical sensor controller 258 in I/O subsystem 206. The optical sensor 264 may include charge-coupled device (CCD) or complementary metal-oxide semiconductor (CMOS) phototransistors. The optical sensor 264 receives light from the environment, projected through one or more lens, and converts the light to data representing an image. In conjunction with an imaging module 243 (also called a camera module), the optical sensor 264 may capture still images or video. In some embodiments, an optical sensor is located on the back of the device 200, opposite the touch screen display 212 on the front of the device, so that the touch screen display may be used as a viewfinder for either still and/or video image acquisition.

In some embodiments, an optical sensor is located on the front of the device so that the user's image may be obtained for videoconferencing while the user views the other video conference participants on the touch screen display. In some embodiments, the position of the optical sensor 264 can be changed by the user (e.g., by rotating the lens and the sensor in the device housing) so that a single optical sensor 264 may be used along with the touch screen display for both video conferencing and still and/or video image acquisition.

The device 200 may also include one or more proximity sensors 266. FIG. 5 shows a proximity sensor 266 coupled to the peripherals interface 218. Alternately, the proximity sensor 266 may be coupled to an input controller 260 in the I/O subsystem 206. The proximity sensor 266 may perform as described in U.S. patent application Ser. No. 11/241,839, “Proximity Detector In Handheld Device,” filed Sep. 30, 2005; Ser. No. 11/240,788, “Proximity Detector In Handheld Device,” filed Sep. 30, 2005; Ser. No. 11/620,702, “Using Ambient Light Sensor To Augment Proximity Sensor Output”; Ser. No. 11/586,862, “Automated Response To And Sensing Of User Activity In Portable Devices,” filed Oct. 24, 2006; and Ser. No. 11/638,251, “Methods And Systems For Automatic Configuration Of Peripherals,” which are hereby incorporated by reference in their entirety. In some 1115 embodiments, the proximity sensor turns off and disables the touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

The device 200 may also include one or more accelerometers 268. FIG. 5 shows an accelerometer 268 coupled to the peripherals interface 218. Alternately, the accelerometer 268 may be coupled to an input controller 260 in the I/O subsystem 206. The accelerometer 268 may perform as described in U.S. Patent Publication No. 20050190059, “Acceleration-based Theft Detection System for Portable Electronic Devices,” and U.S. Patent Publication No. 20060017692, “Methods and Apparatuses for Operating a Portable Device Based on An Accelerometer,” both of which are which are incorporated by reference in their entirety. In some embodiments, information is displayed on the touch screen display in a portrait view or a landscape view based on an analysis of data received from the 1135 one or more accelerometers.

In some embodiments, the software components stored in memory 202 may include an operating system 226, a communication module (or set of instructions) 228, a contact/motion module (or set of instructions) 230, a graphics module (or set of instructions) 232, a text input module (or set of instructions) 234, a Global Positioning System (GPS) module (or set of instructions) 235, and applications (or set of instructions) 236.

The operating system 226 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 228 facilitates communication with other devices over one or more external ports 224 and also includes various software components for handling data received by the RF/NFC circuitry 208 and/or the external port 224. The external port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Computer, Inc.) devices.

The contact/motion module 230 may detect contact with the touch screen 212 (in conjunction with the display controller 256) and other touch sensitive devices (e.g., a touchpad or physical click wheel). The contact/motion module 230 includes various software components for performing various operations related to detection of contact, such as determining if contact has occurred, determining if there is movement of the contact and tracking the movement across the touch screen 212, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multi-touch”/multiple finger contacts). In some embodiments, the contact/motion module 230 and the display controller 256 also detects contact on a touchpad. In some embodiments, the contact/motion module 230 and the controller 260 detects contact on a click wheel.

The graphics module 232 includes various known software components for rendering and displaying graphics on the touch screen 212, including components for changing the intensity of graphics that are displayed. As used herein, the term “graphics” includes any object that can be displayed to a user, including without limitation text, web pages, icons (such as user-interface objects including soft keys), digital images, videos, animations and the like. An animation in this context is a display of a sequence of images that gives the appearance of movement, and informs the user of an action that has been performed (such as moving an email message to a folder). In this context, a respective animation that confirms an action by the user of the device typically takes a predefined, finite amount of time, such as an amount of time between 0.2 and 1.0 seconds, or between 0.5 and 2.0 seconds, depending on the context.

The text input module 234, which may be a component of graphics module 232, provides soft keyboards for entering text in various applications (e.g., contacts 237, e-mail 240, IM 241, blogging 242, browser 247, and any other application that needs text input).

The GPS module 235 determines the location of the device and provides this information for use in various applications (e.g., to telephone 238 for use in location-based dialing, to camera 243 and/or blogger 242 as picture/video metadata, and to applications that provide location-based services such as weather widgets, local yellow page widgets, and map/navigation widgets).

The applications 236 may include the following modules (or sets of instructions), or a subset or superset thereof:

a contacts module 237 (sometimes called an address book or contact list);

a telephone module 238;

a video conferencing module 239;

an e-mail client module 240; 1215 [0190] an instant messaging (IM) module 241;

a blogging module 242;

a camera module 243 for still and/or video images;

an image management module 244;

a video player module 245;

a music player module 246;

a browser module 247;

a calendar module 248;

widget modules 249, which may include weather widget 249-1, stocks widget 249-2, calculator widget 249-3, alarm clock 1225 widget 249-4, dictionary widget 249-5, and other widgets obtained by the user, as well as user-created widgets 249-6;

widget creator module 250 for making user-created widgets 249-6;

search module 251;

video and music player module 252, which merges video player module 245 and music player module 246;

notes module 253; and/or

map module 254.

Examples of other applications 236 that may be stored in memory 202 include other word processing applications, JAVA-enabled applications, encryption, digital rights management, voice recognition, and voice replication.

In conjunction with touch screen 212, display controller 256, contact module 230, graphics module 232, and text input module 234, the contacts module 237 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 238, video conference 239, e-mail 240, or IM 241; and so forth. Embodiments of user interfaces and associated processes using contacts module 237 are described further below.

In conjunction with RF/NFC circuitry 208, audio circuitry 210, speaker 211, microphone 213, touch screen 212, display controller 256, contact module 230, graphics module 232, and text input module 234, the telephone module 238 may be used to enter a sequence of characters corresponding to a telephone number, access one or more telephone numbers in the address book 237, modify a telephone number that has been entered, dial a respective telephone number, conduct a conversation and disconnect or hang up when the conversation is completed. As noted above, the wireless communication may use any of a plurality of communications standards, protocols and technologies. Embodiments of user interfaces and associated processes using telephone module 238 are described further below.

In conjunction with RF/NFC circuitry 208, audio circuitry 210, speaker 211, microphone 213, touch screen 212, display controller 256, optical sensor 264, optical sensor controller 258, contact module 230, graphics module 232, text input module 234, contact list 237, and telephone module 238, the videoconferencing module 239 may be used to initiate, conduct, and terminate a video conference between a user and one or more other participants.

In conjunction with RF/NFC circuitry 208, touch screen 212, display controller 256, contact module 230, graphics module 232, and text input module 234, the e-mail client module 240 may be used to create, send, receive, and manage e-mail. In conjunction with image management module 244, the e-mail module 240 makes it very easy to create and send e-mails with still or video images taken with camera module 243. Embodiments of user interfaces and associated processes using e-mail module 240 are described further below.

In conjunction with RF/NFC circuitry 208, touch screen 212, display controller 256, contact module 230, graphics module 232, and text input module 234, the instant messaging module 241 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS). Embodiments of user interfaces and associated processes using instant messaging module 241 are described further below.

In conjunction with RF/NFC circuitry 208, touch screen 212, display controller 256, contact module 230, graphics module 232, text input module 234, image management module 244, and browsing module 247, the blogging module 242 may be used to send 1305 text, still images, video, and/or other graphics to a blog (e.g., the user's blog).

In conjunction with touch screen 212, display controller 256, optical sensor(s) 264, optical sensor controller 258, contact module 230, graphics module 232, and image management module 244, the camera module 243 may be used to capture still images or video (including a video stream) and store them into memory 202, modify characteristics of a still image or video, or delete a still image or video from memory 202. Embodiments of user interfaces and associated processes using camera module 243 are described further below.

In conjunction with touch screen 212, display controller 256, contact module 230, graphics module 232, text input module 234, and camera module 243, the image management module 244 may be used to arrange, modify or otherwise manipulate, label, delete, present (e.g., in a digital slide show or album), and store still and/or video images. Embodiments of user interfaces and associated processes using image management module 244 are described further below.

In conjunction with touch screen 212, display controller 256, contact module 230, graphics module 232, audio circuitry 210, and speaker 211, the video player module 245 may be used to display, present or otherwise play back videos (e.g., on the touch screen or on an external, connected display via external port 224). Embodiments of user interfaces and associated processes using video player module 245 are described further below.

In conjunction with touch screen 212, display system controller 256, contact module 230, graphics module 232, audio circuitry 210, speaker 211, RF/NFC circuitry 208, and browser module 247, the music player module 246 allows the user to download and play back recorded music and other sound files stored in one or more file formats, such as MP3 or AAC files. In some embodiments, the device 200 may include the functionality of an MP3 player, such as an iPod (trademark of Apple Computer, Inc.). Embodiments of user interfaces and associated processes using music player module 246 are described further below.

In conjunction with RF/NFC circuitry 208, touch screen 212, display system controller 256, contact module 230, graphics module 232, and text input module 234, the browser module 247 may be used to browse the Internet, including searching, linking to, receiving, and displaying web pages or portions thereof, as well as attachments and other files linked to web pages. Embodiments of user interfaces and associated processes using browser module 247 are described further below.

In conjunction with RF/NFC circuitry 208, touch screen 212, display system controller 256, contact module 230, graphics module 232, text input module 234, e-mail module 240, and browser module 247, the calendar module 248 may be used to create, display, modify, and store calendars and data associated with calendars (e.g., calendar entries, to do lists, etc.). Embodiments of user interfaces and associated processes using calendar module 248 are described further below.

In conjunction with RF/NFC circuitry 208, touch screen 212, display system controller 256, contact module 230, graphics module 232, text input module 234, and browser module 247, the widget modules 249 are mini-applications that may be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF/NFC circuitry 208, touch screen 212, display system controller 256, contact module 230, graphics module 232, text input module 234, and browser module 247, the widget creator module 250 may be used by a user to create widgets (e.g., turning a user-specified portion of a web page into a widget).

In conjunction with touch screen 212, display system controller 256, contact module 230, graphics module 232, and text input module 234, the search module 251 may be used to search for text, music, sound, image, video, and/or other files in memory 202 that match one or more search criteria (e.g., one or more user-specified search terms).

In conjunction with touch screen 212, display controller 256, contact module 230, graphics module 232, and text input module 234, the notes module 253 may be used to create and manage notes, to do lists, and the like.

In conjunction with RF/NFC circuitry 208, touch screen 212, display system controller 256, contact module 230, graphics module 232, text input module 234, GPS module 235, and browser module 247, the map module 254 may be used to receive, display, modify, and store maps and data associated with maps (e.g., driving directions; data on stores and other points of interest at or near a particular location; and other location-based data).

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 245 may be combined with music player module 246 into a single module (e.g., video and music player module 252, FIG. 4B). In some embodiments, memory 202 may store a subset of the modules and data structures identified above. Furthermore, memory 202 may store additional modules and data structures not described above.

In some embodiments, the device 200 is a device where operation of a predefined set of functions on the device is performed exclusively through a touch screen 212 and/or a touchpad. By using a touch screen and/or a touchpad as the primary input/control device for operation of the device 200, the number of physical input/control devices (such as push buttons, dials, and the like) on the device 200 may be reduced.

The predefined set of functions that may be performed exclusively through a touch screen and/or a touchpad include navigation between user interfaces. In some embodiments, the touchpad, when touched by the user, navigates the device 200 to a main, home, or root menu from any user interface that may be displayed on the device 200. In such embodiments, the touchpad may be referred to as a “menu button.” In some other embodiments, the menu button may be a physical push button or other physical input/control device instead of a touchpad.

FIG. 6 illustrates a portable multifunction device 200 having a touch screen 212 in accordance with some embodiments. The touch screen may display one or more graphics within user interface (UI) 300. In this embodiment, as well as others described below, a user may select one or more of the graphics by making contact or touching the graphics, for example, with one or more fingers 302 (not drawn to scale in the FIGURE). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has contacted the device 100. In some embodiments, inadvertent contact with a graphic may not select the graphic. For example, a swipe gesture that sweeps over an application icon may not select the corresponding application when the gesture corresponding to selection is a tap.

The device 200 may also include one or more physical buttons, such as “home” or menu button 304. As described previously, the menu button 304 may be used to navigate to any application 136 in a set of applications that may be executed on the device 100. Alternatively, in some embodiments, the menu button is implemented as a soft key in a GUI in touch screen 112.

In one embodiment, the device 200 includes a touch screen 212, a menu button 304, a push button 306 for powering the device on/off and locking the device, volume adjustment button(s) 308, a Subscriber Identity Module (SIM) card slot 310, a head set jack 312, and a docking/charging external port 124. The push button 306 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, the device 100 also may accept verbal input for activation or deactivation of some functions through the microphone 113.

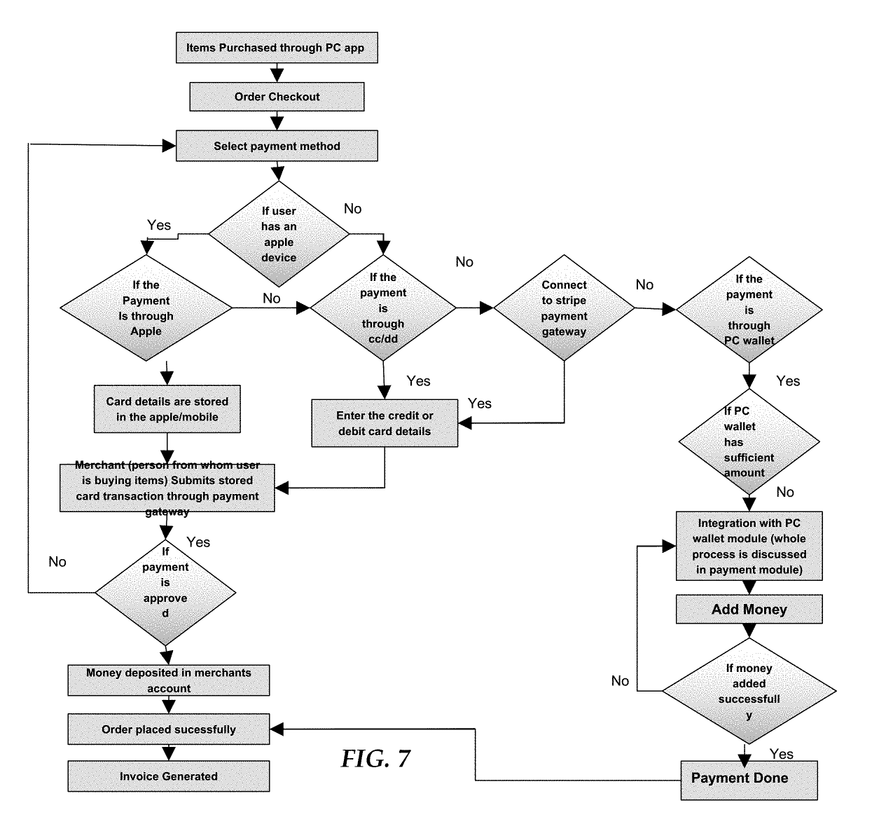

FIG. 7 illustrates the order checkout process features and functions of the disclosed subject matter to illustrate the novel steps and instructions that an embodiment may perform for communicating and transacting between a passenger, a purchaser, and a flight attendant on a passenger airline for improving the enjoyment and optimizing the business efficiency of time spent traveling. Exemplary electronic devices and computer processors and networks for performing the functions of the present disclosure appear herein at FIGS. 3 through 6. The features and steps appearing in FIG. 7 are included in this paragraph to the full extent as though expressly here written.

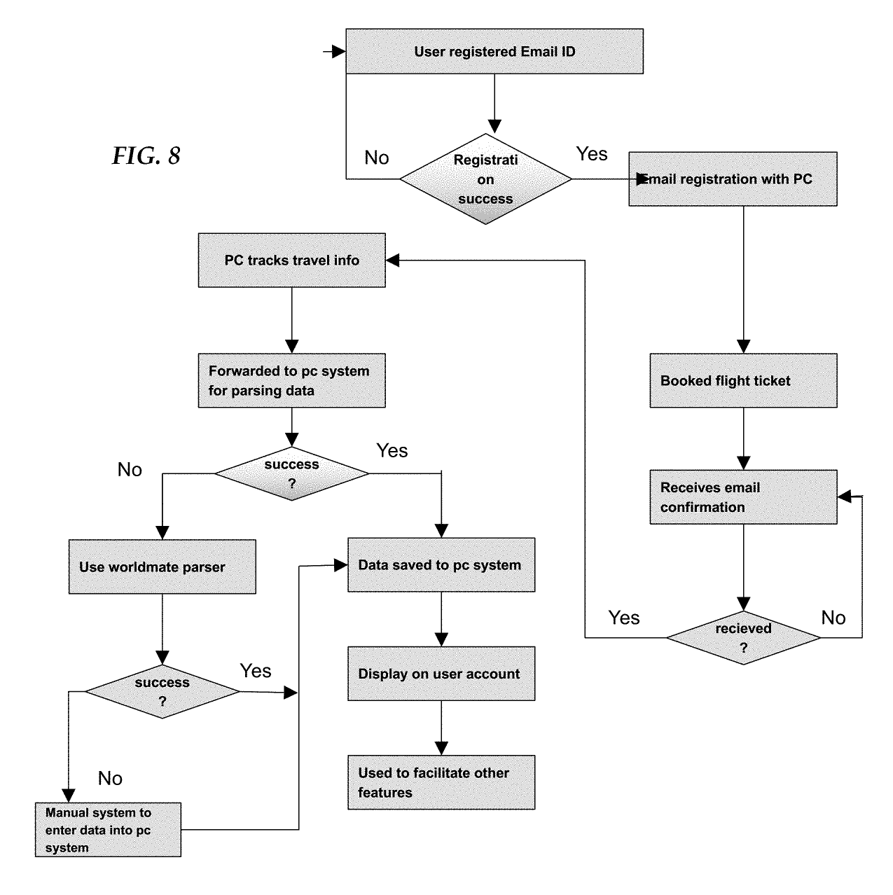

FIG. 8 shows the registration process features and functions of the disclosed subject matter to illustrate the novel steps and instructions that an embodiment may perform for communicating and transacting between a passenger, a purchaser, and a flight attendant on a passenger airline for improving the enjoyment and optimizing the business efficiency of time spent traveling. Exemplary electronic devices and computer processors and networks for performing the functions of the present disclosure appear herein at FIGS. 3 through 6. The features and steps appearing in FIG. 8 are included in this paragraph to the full extent as though expressly here written.

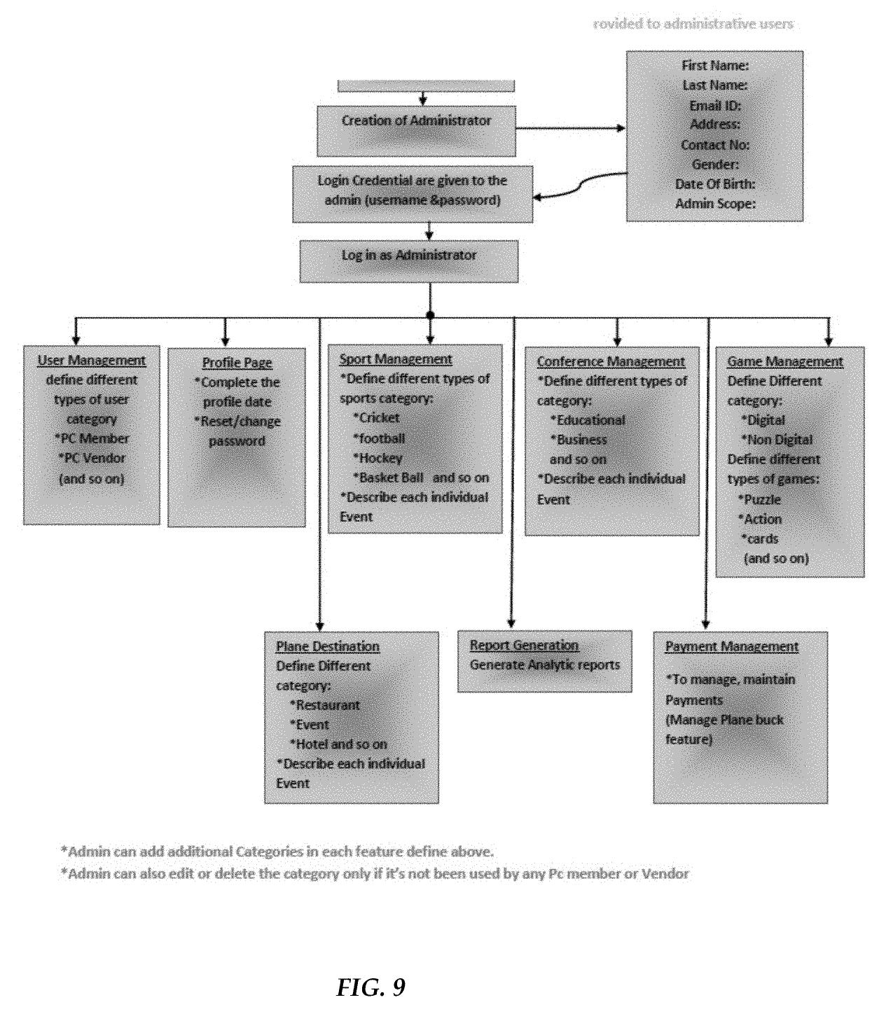

FIG. 9 illustrates the login process associated with an administrator for administrating features and functions of the disclosed subject matter to illustrate the novel steps and instructions that an embodiment may perform for communicating and transacting between passengers and improve the efficiency of time spent traveling. Exemplary electronic devices and computer processors and networks for performing the functions of the present disclosure appear herein at FIGS. 3 through 6. The features and steps appearing in FIG. 9 are included in this paragraph to the full extent as though expressly here written.

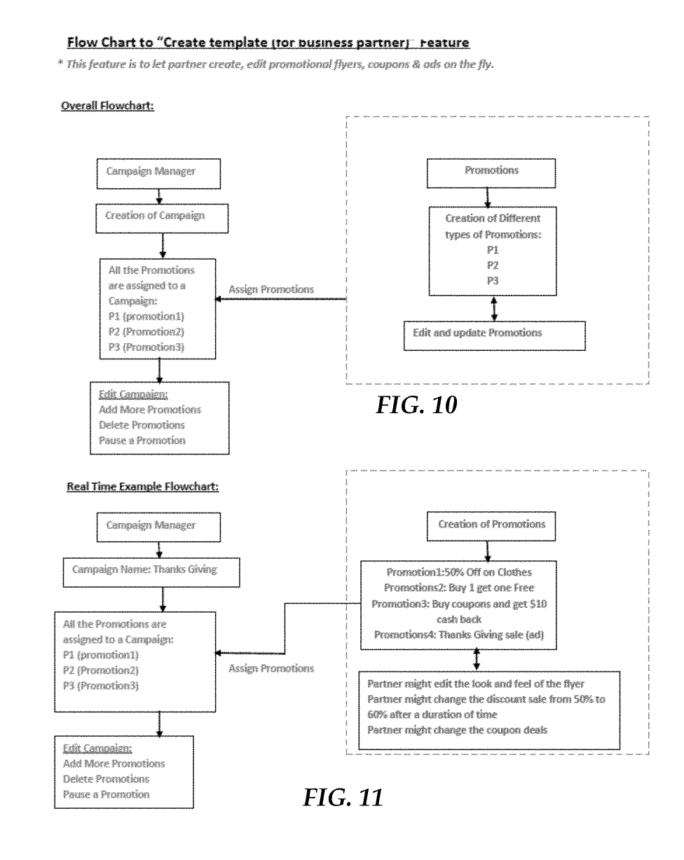

FIG. 10 shows an overall flow chart for creating a campaign whereby a vendor or advertiser may interface with the system to facilitate the use of vendor or sales information for a purchaser and further details the associated features and functions of the disclosed subject matter to illustrate the novel steps and instructions that an embodiment may perform for communicating and transacting between travelers and improve the efficiency of time spent traveling. Exemplary electronic devices and computer processors and networks for performing the functions of the present disclosure appear herein at FIGS. 3 through 6. The features and steps appearing in FIG. 10 are included in this paragraph to the full extent as though expressly here written.

FIG. 11 shows a real-time examples of a chart for providing additional campaign information from a partner or other vendor who may interface with the system of the present disclosure and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 11 are included in this paragraph to the full extent as though expressly here written.

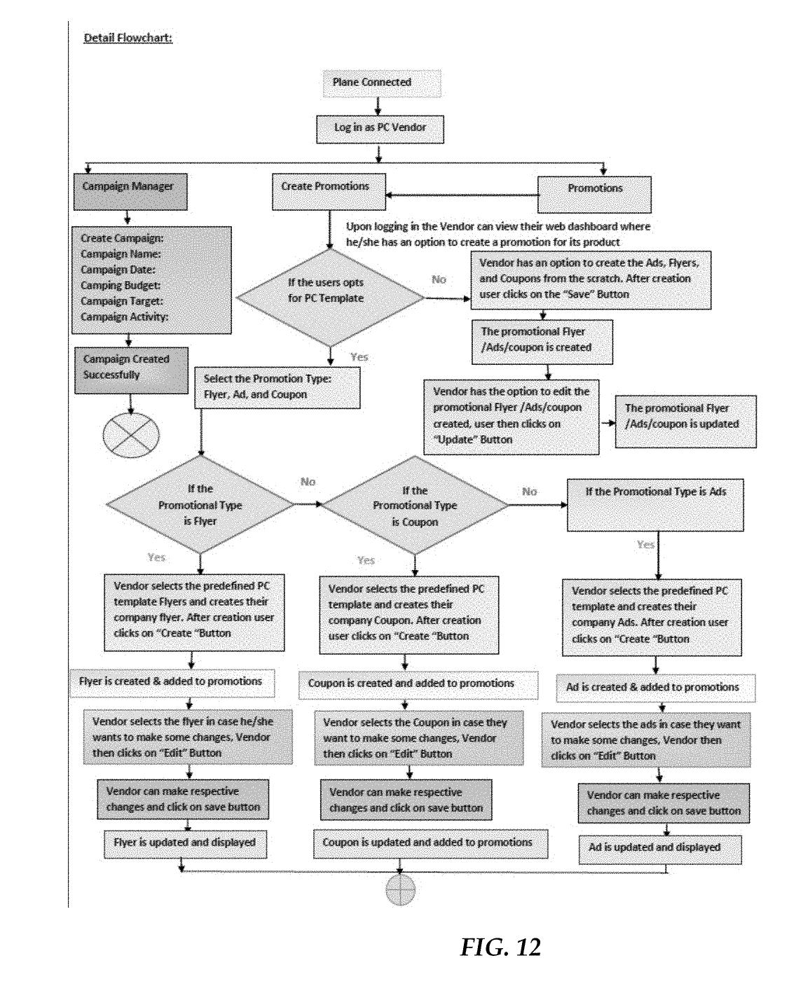

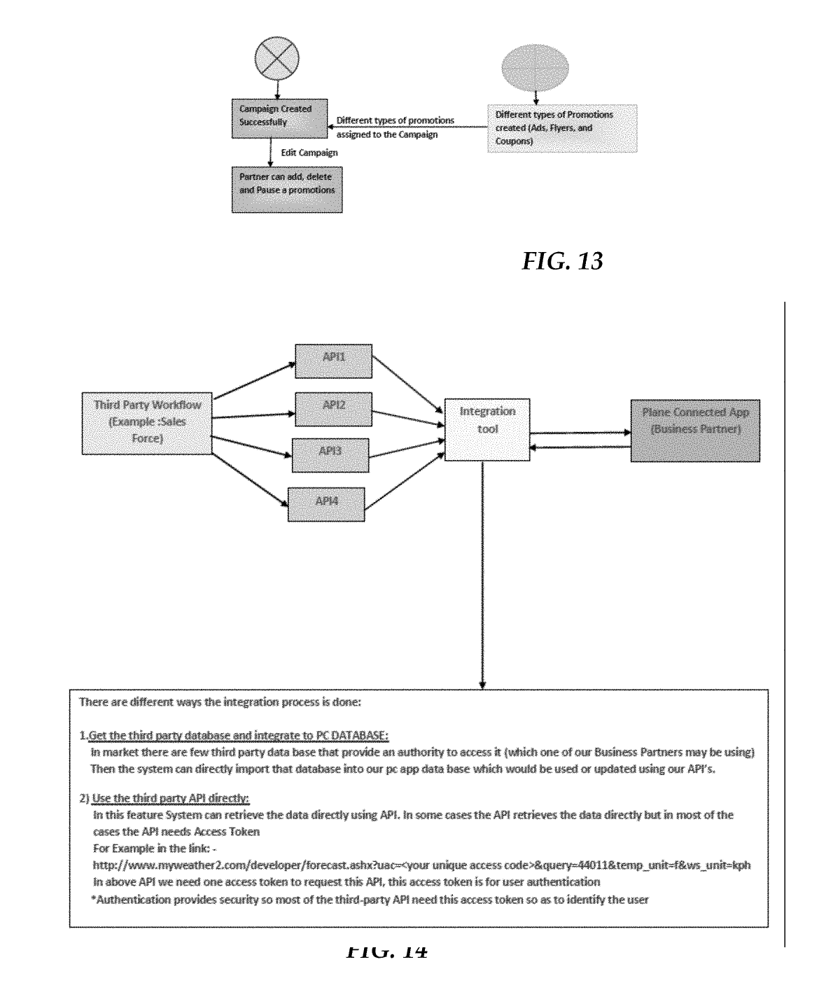

FIGS. 12 and 13 show how an advertiser may interact with an airport vendor to interface with the system of a present disclosure and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIGS. 12 and 13 are included in this paragraph to the full extent as though expressly here written.

FIG. 14 illustrates third-party workflow using third-party API's and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 14 are included in this paragraph to the full extent as though expressly here written.

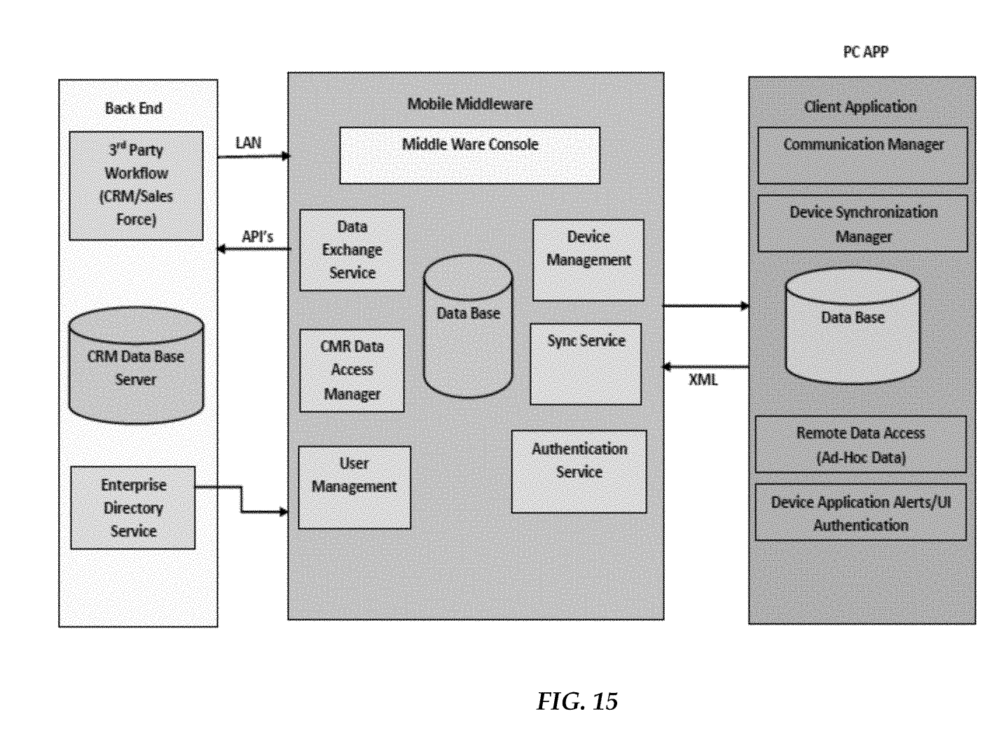

FIG. 15 illustrates how various databases interconnect with the system at the present disclosure. This may include certain CRM database servers, associated with mobile middleware, and Kline application for the system of the present disclosure. FIG. 15 further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 15 are included in this paragraph to the full extent as though expressly here written.

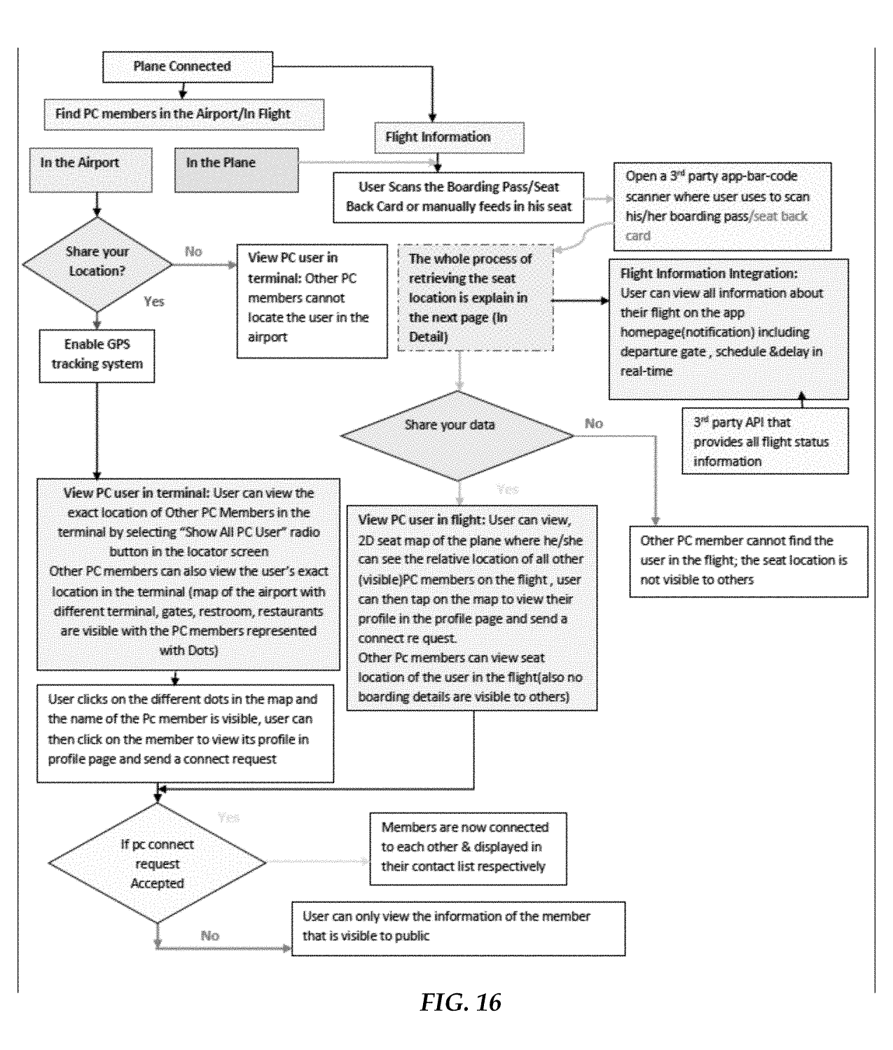

FIG. 16 shows processes applicable to the Plane Layover and Plane Nice aspects of the present disclosure and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 16 are included in this paragraph to the full extent as though expressly here written.

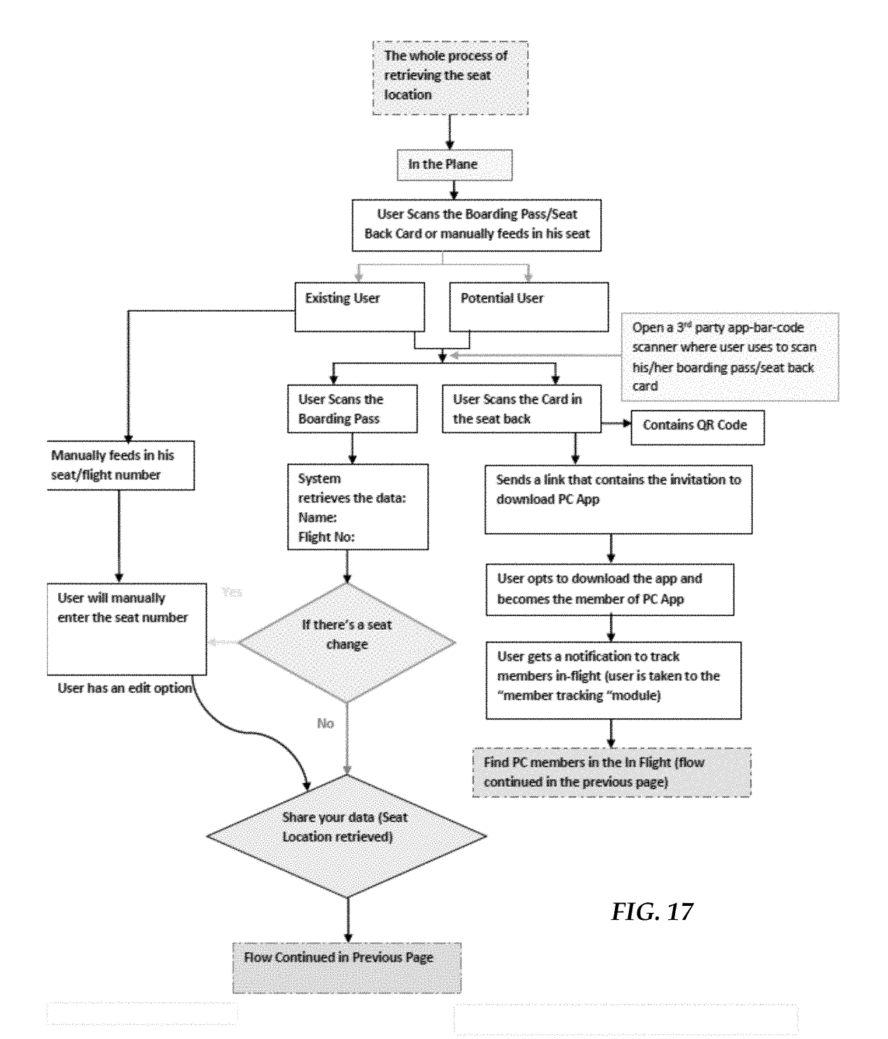

FIG. 17 shows how the present system identifies the location of a particular user on an airplane for the purpose of providing the benefits and gifts that the present disclosure enables. One aspect of the present disclosure is the including on a logo or sticker on the passenger tray in a Southwest Airlines flight. This particular identifier would indicate the location of the sea in the location of the user and thereby be able to identify where the particular user is in the scenario where they use for just not have a pre-assigned seat or where the user has changed his it's position with a pre-assigned seat.

FIG. 17 further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 17 are included in this paragraph to the full extent as though expressly here written.

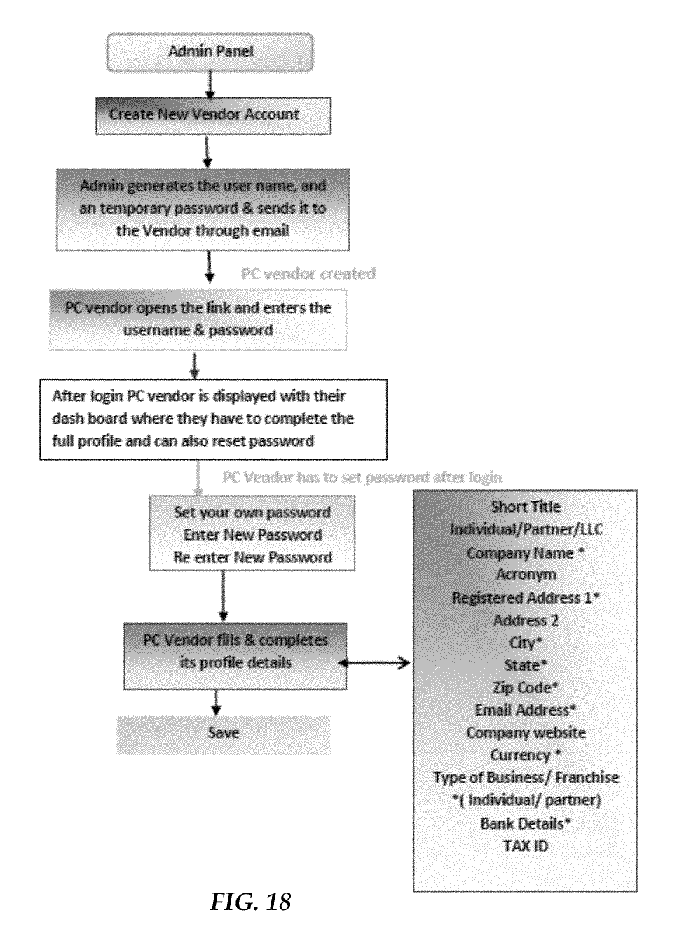

FIG. 18 illustrates the functions of the present system wherein a user populates a user profile for use within the system and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 18 are included in this paragraph to the full extent as though expressly here written.

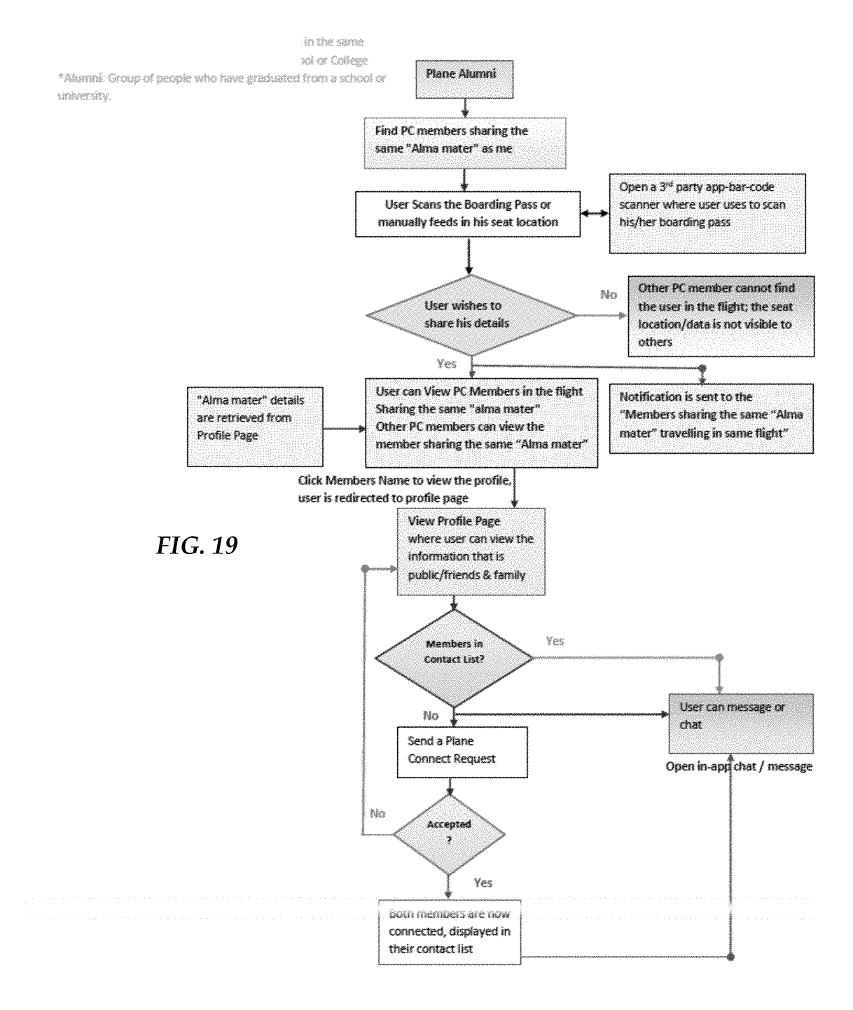

FIG. 19 illustrates the Plane Alumni features of the present disclosure for identifying and providing benefits to alumni of universities, associations, the military, other affinity groups for gifting and other purposes. FIG. 19 further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 19 are included in this paragraph to the full extent as though expressly here written.

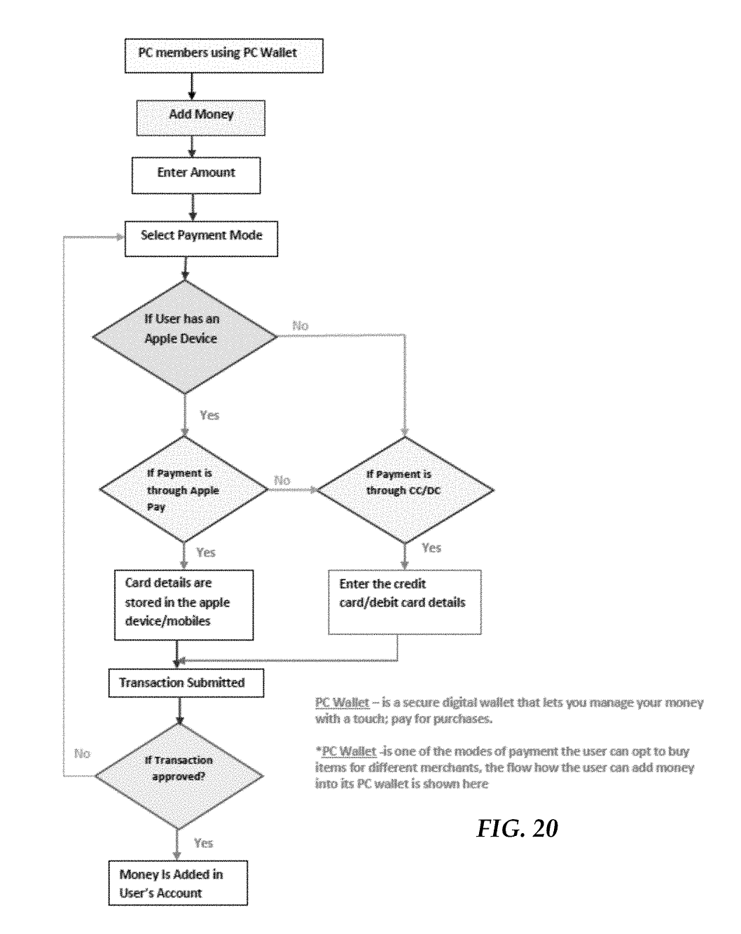

FIG. 20 describes the functions associated with a Plane Connected Wallet feature for use in the system or the present disclosure and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 20 are included in this paragraph to the full extent as though expressly here written.

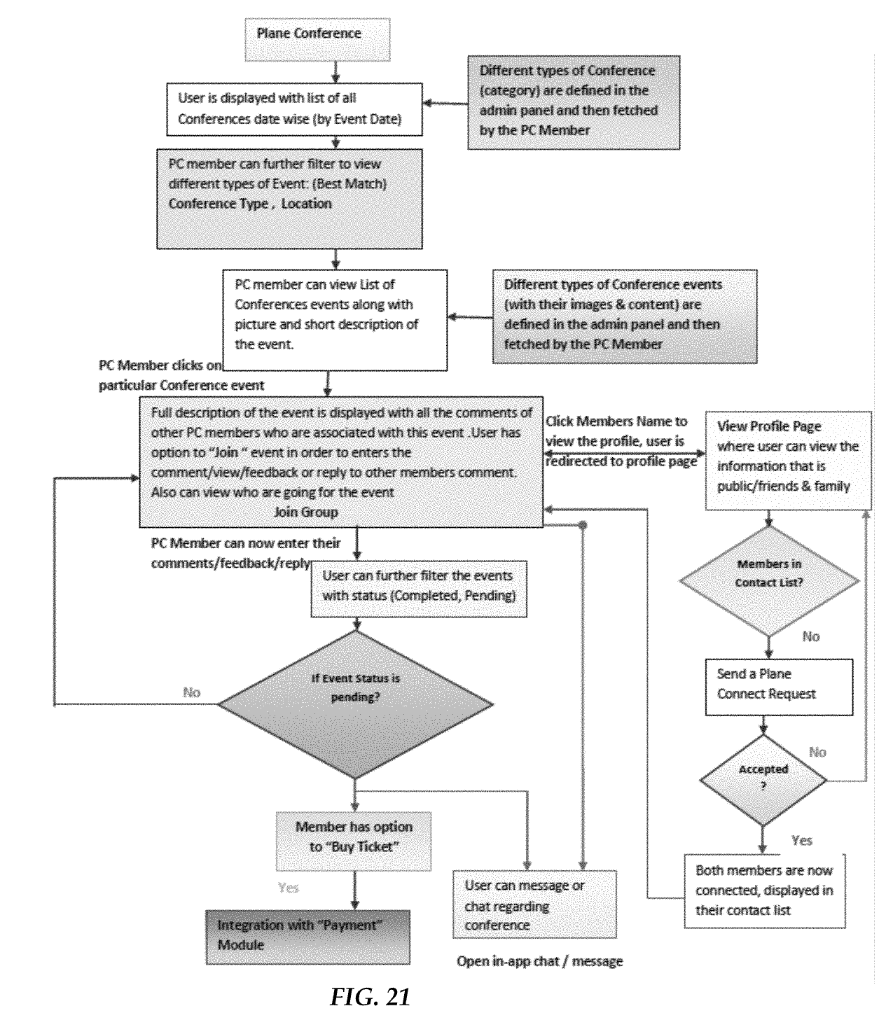

FIG. 21 illustrates the Plane Conference features of the present disclosure whereby our user may receive additional benefits by applying the functions of the present disclosure to the fact that the user is attending an event or conference at the destination of the particular air flight. FIG. 21 and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 21 are included in this paragraph to the full extent as though expressly here written.

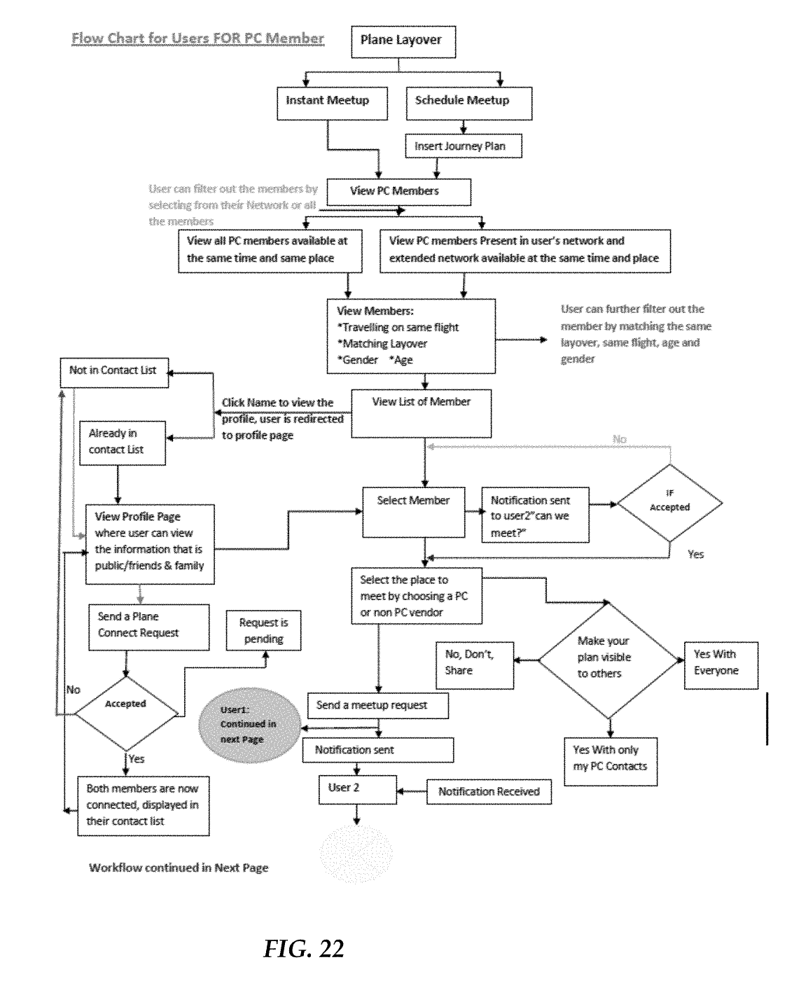

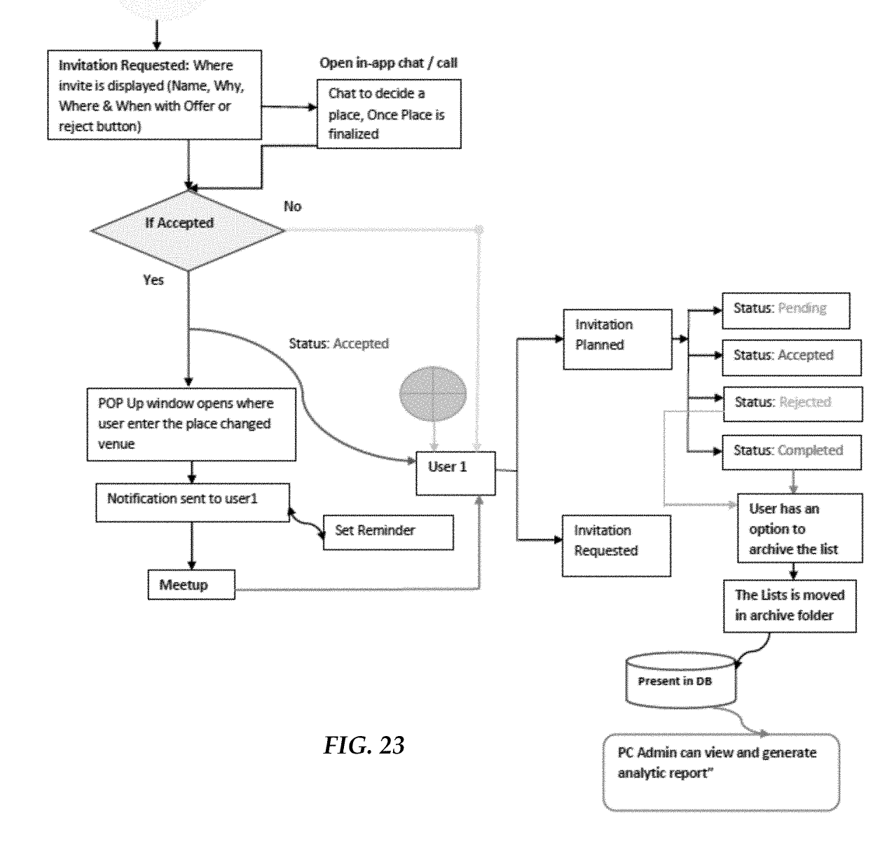

FIGS. 22 and 23 show the features of the present discussing associated with the function of a Plane Layover as described above. FIGS. 22 and 23 and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 10 are included in this paragraph to the full extent as though expressly here written.

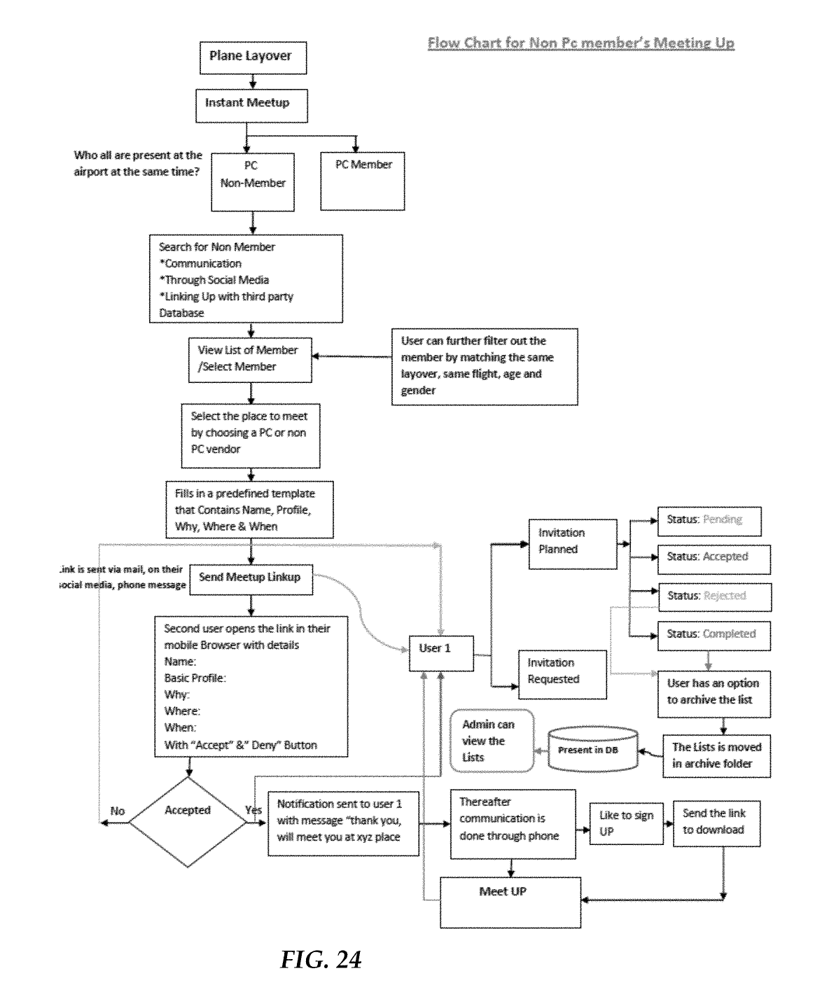

FIG. 24 illustrates how the present disclosure may provide. Layover functions for those individuals who may not be users of the system of the present disclosure and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 24 are included in this paragraph to the full extent as though expressly here written.

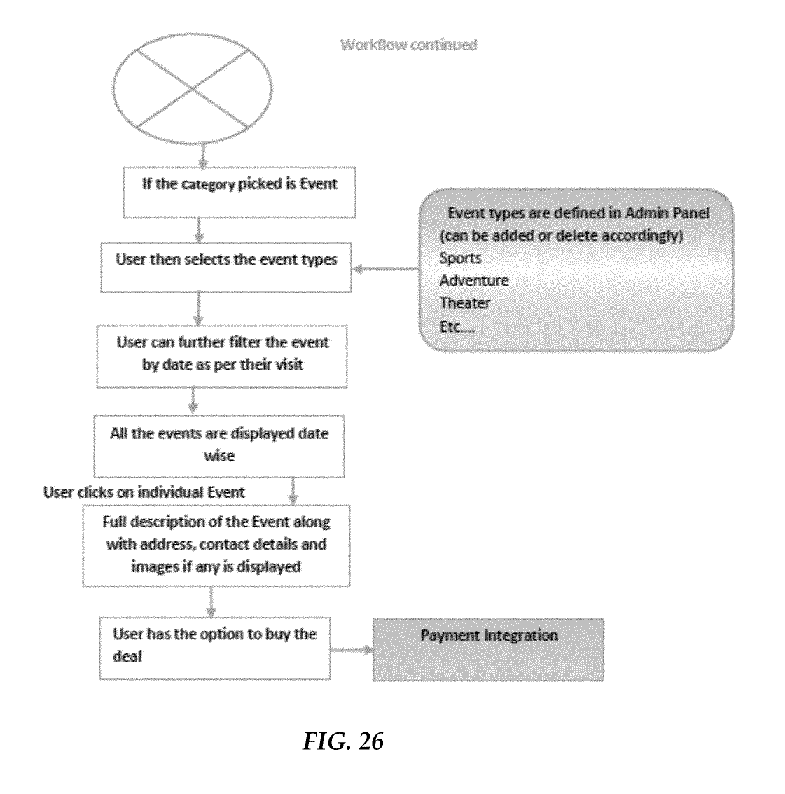

FIGS. 25 and 26 show the plane destination features of the presently disclosed system and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIGS. 25 and 26 are included in this paragraph to the full extent as though expressly here written.

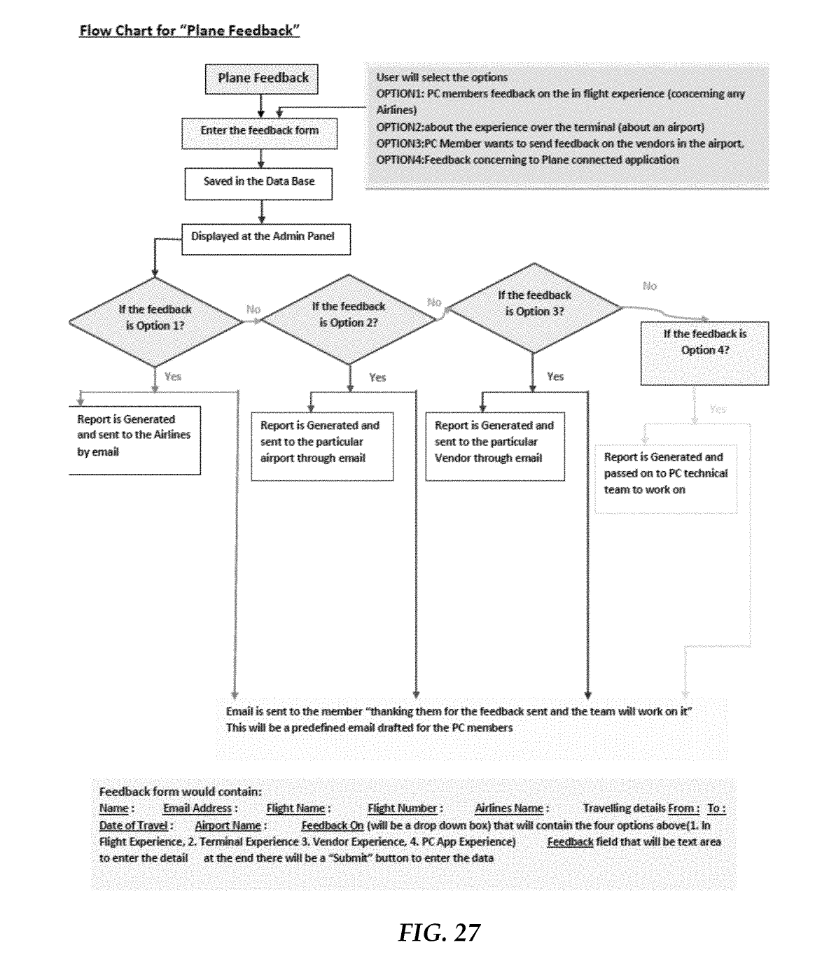

FIG. 27 shows the plane feedback functions of the present disclosure for providing the ability to directly communicate with the airline to address any particular problems or any particular benefits that the user has experienced in the flight. In the event of a problem, by virtue of identifying the problem quietly, the airline has the ability to correct service and improve the flight experience for everyone associated with future flights. FIG. 27 further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 27 are included in this paragraph to the full extent as though expressly here written.

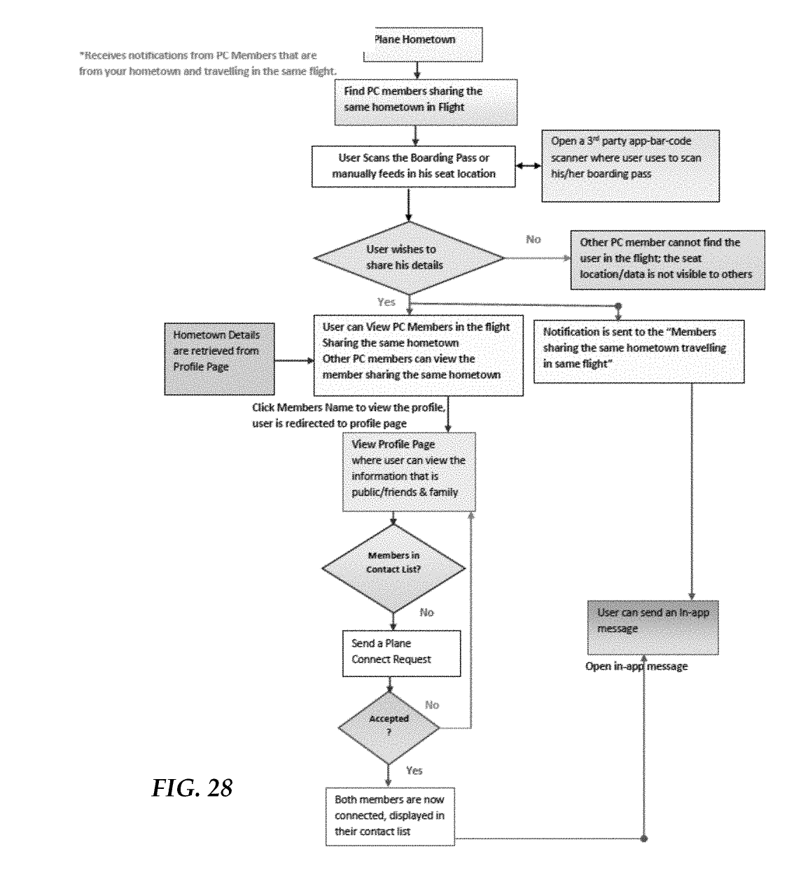

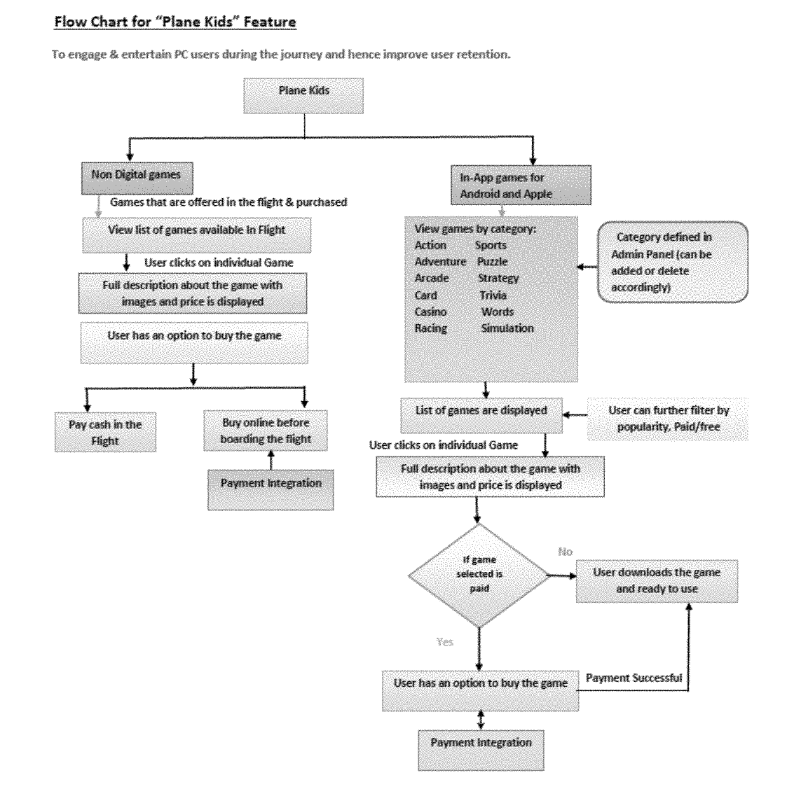

FIG. 28 illustrates the Plane Hometown features of the present disclosure for providing the ability to identify and contact passengers who may have a hometown connection with the particular user. FIG. 28 further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 28 are included in this paragraph to the full extent as though expressly here written.

FIG. 29 illustrates the Plane Kids functions of the present disclosure to provide benefits, entertainment, and other attractive features for the benefit of young passengers. FIG. 29 and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 29 are included in this paragraph to the full extent as though expressly here written.

FIG. 30 provides a functional flowchart for the Plane Nice features of the present disclosure. In association with the process flow FIG. 1, the benefits and features of this of the system of that present disclosure become apparent to a person having ordinary skill in the art of the present disclosure. FIG. 30 and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 30 are included in this paragraph to the full extent as though expressly here written.

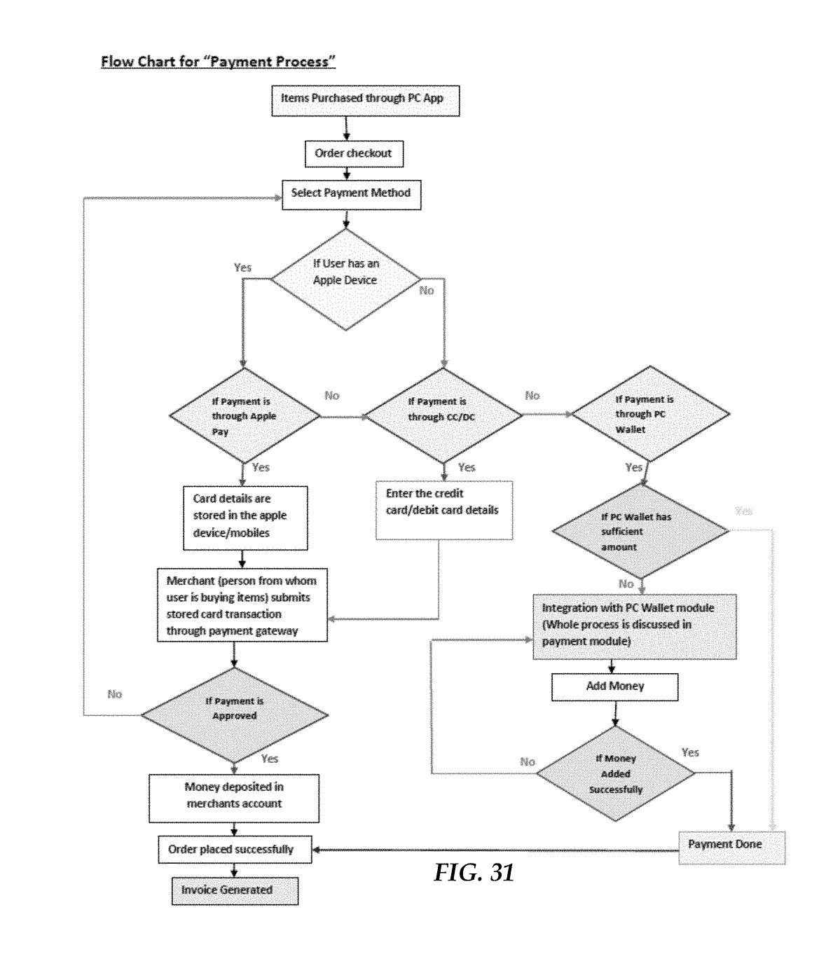

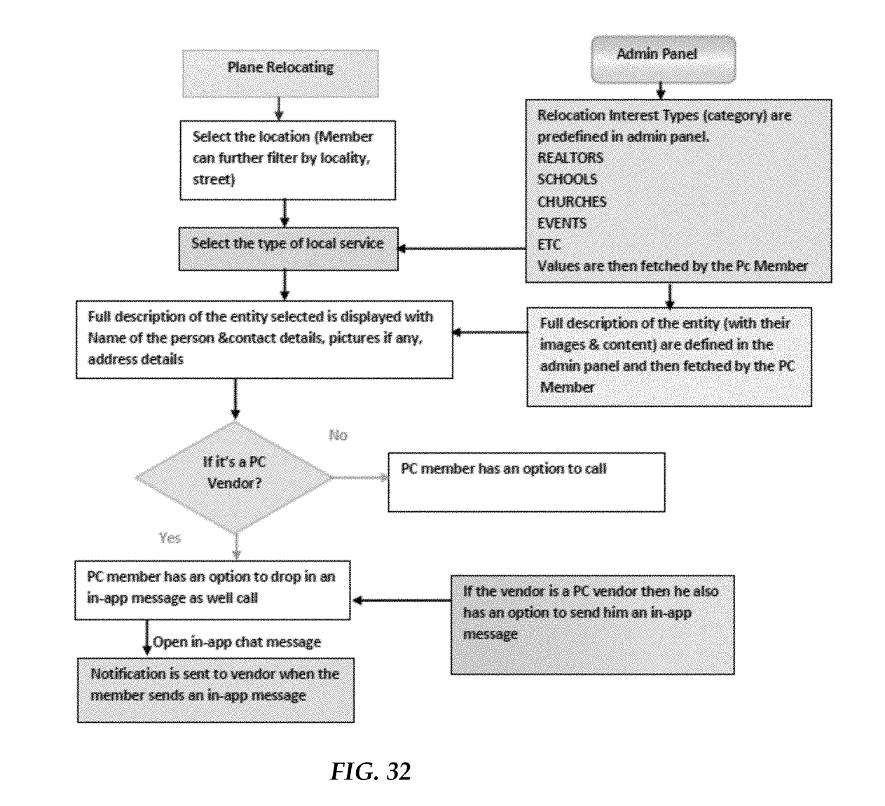

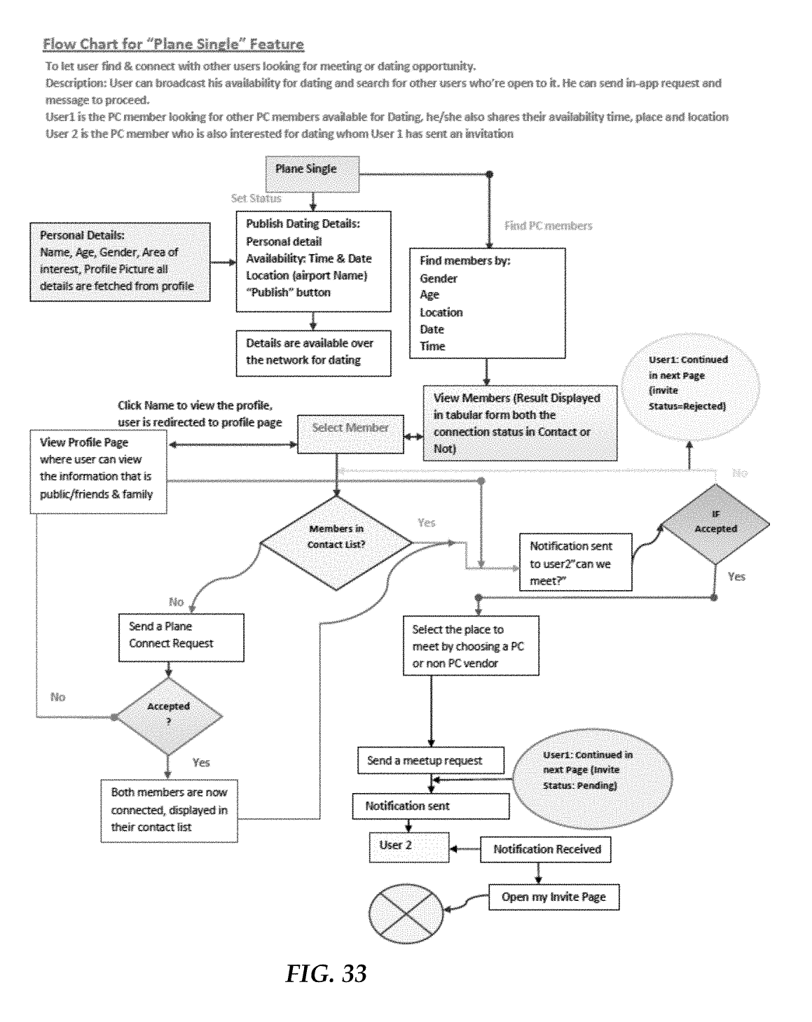

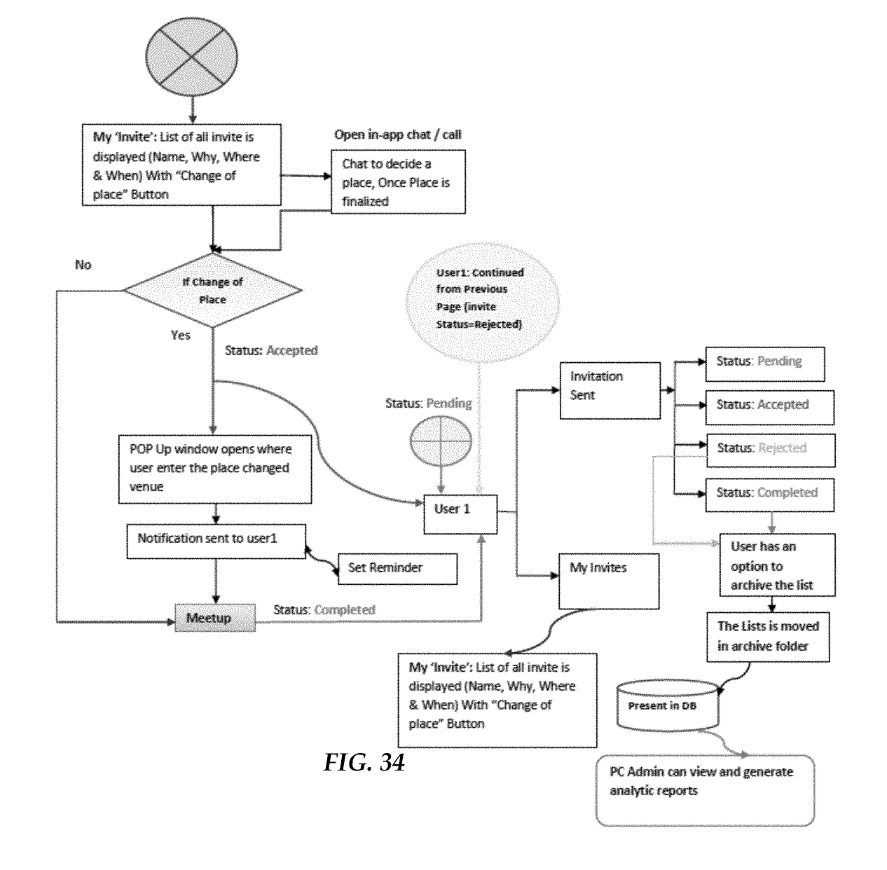

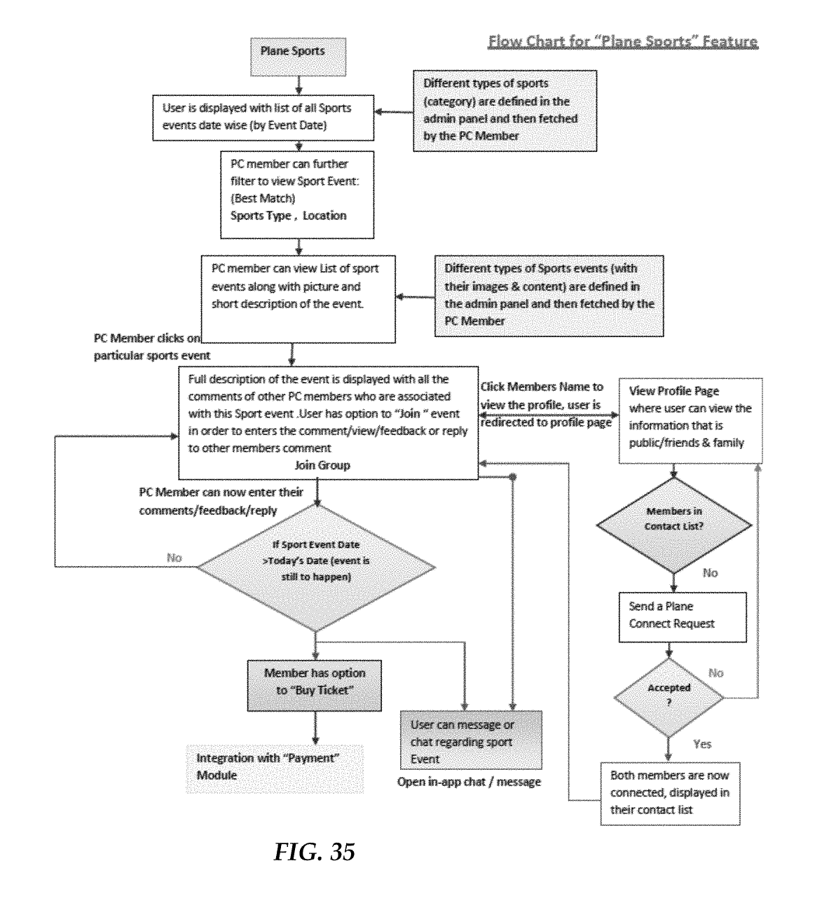

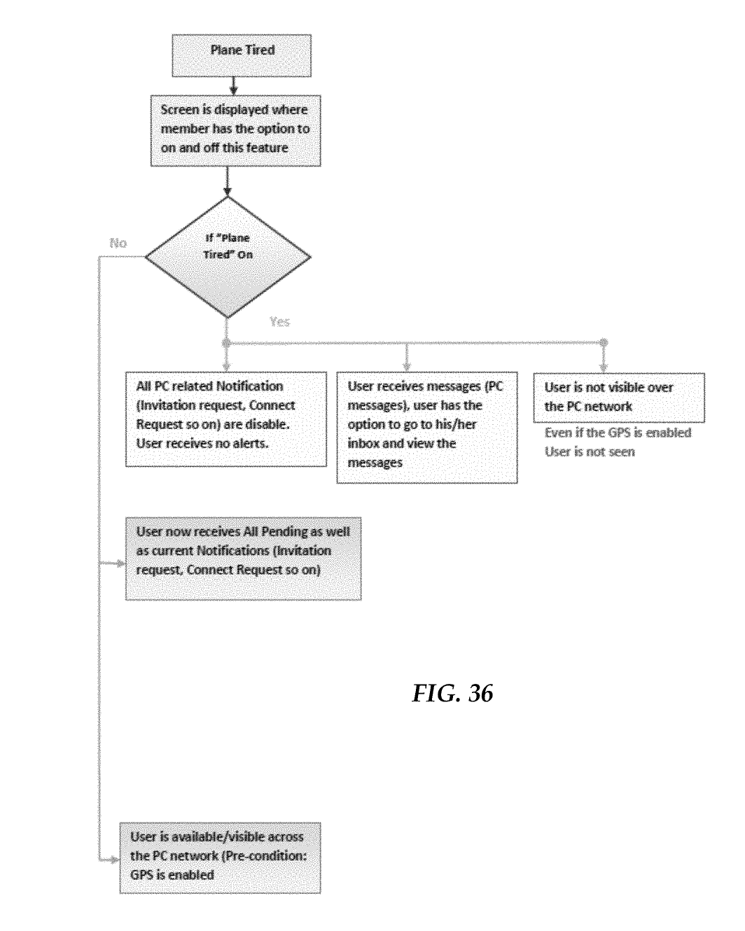

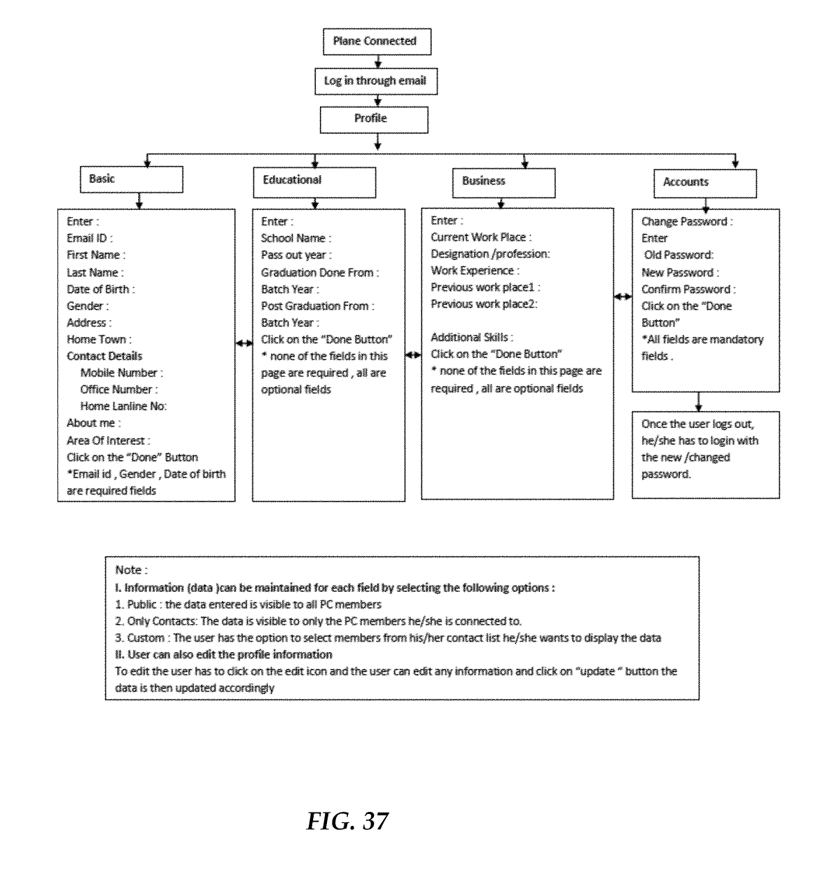

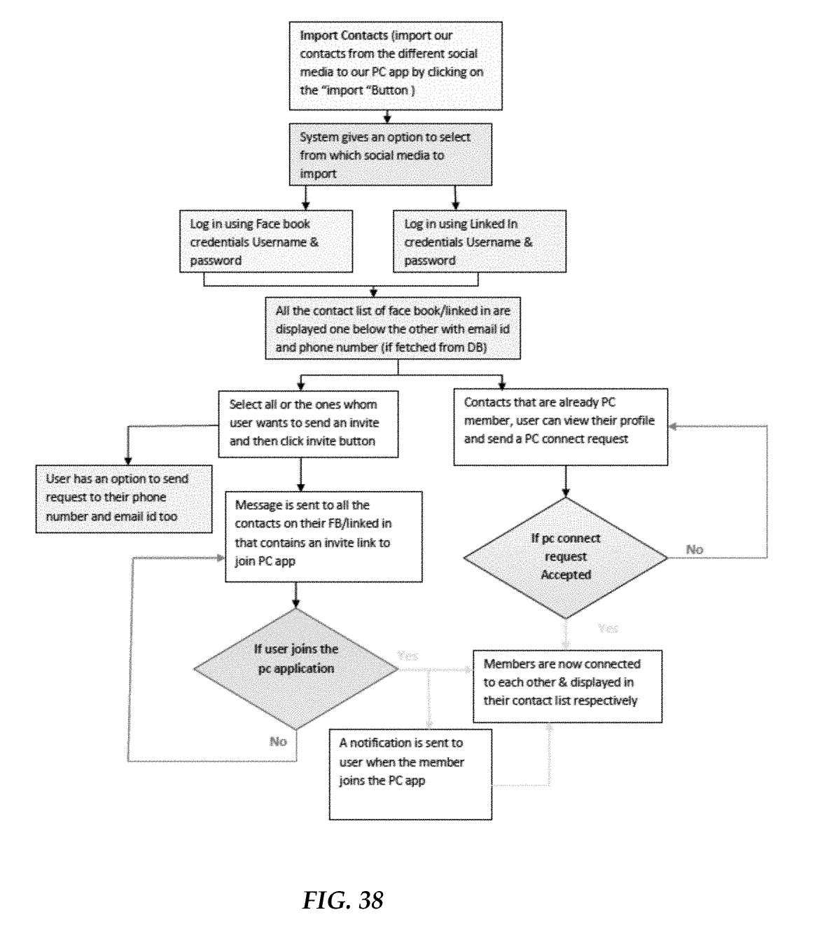

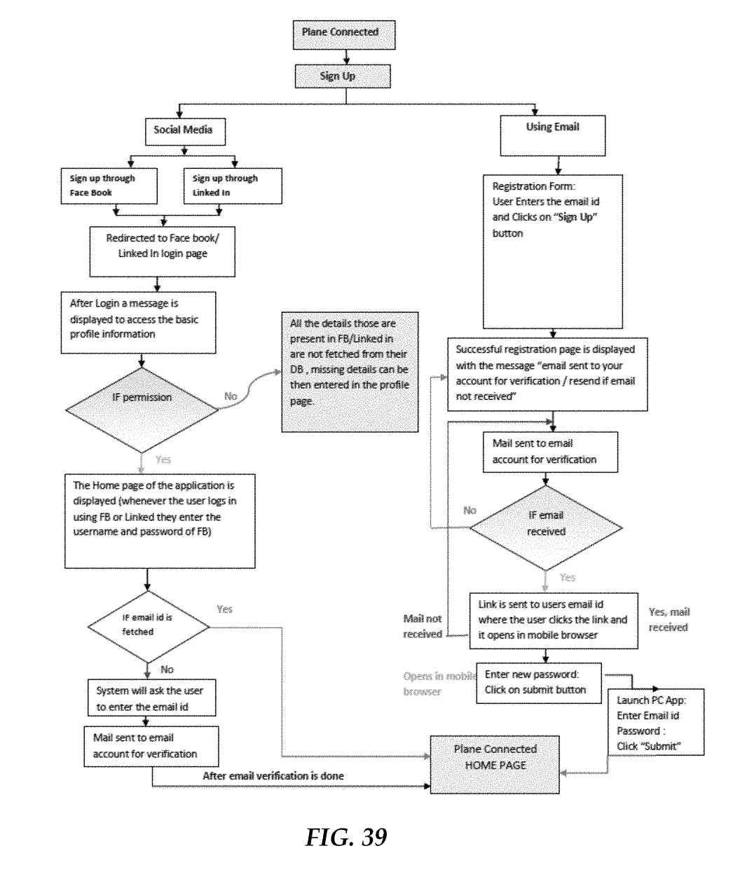

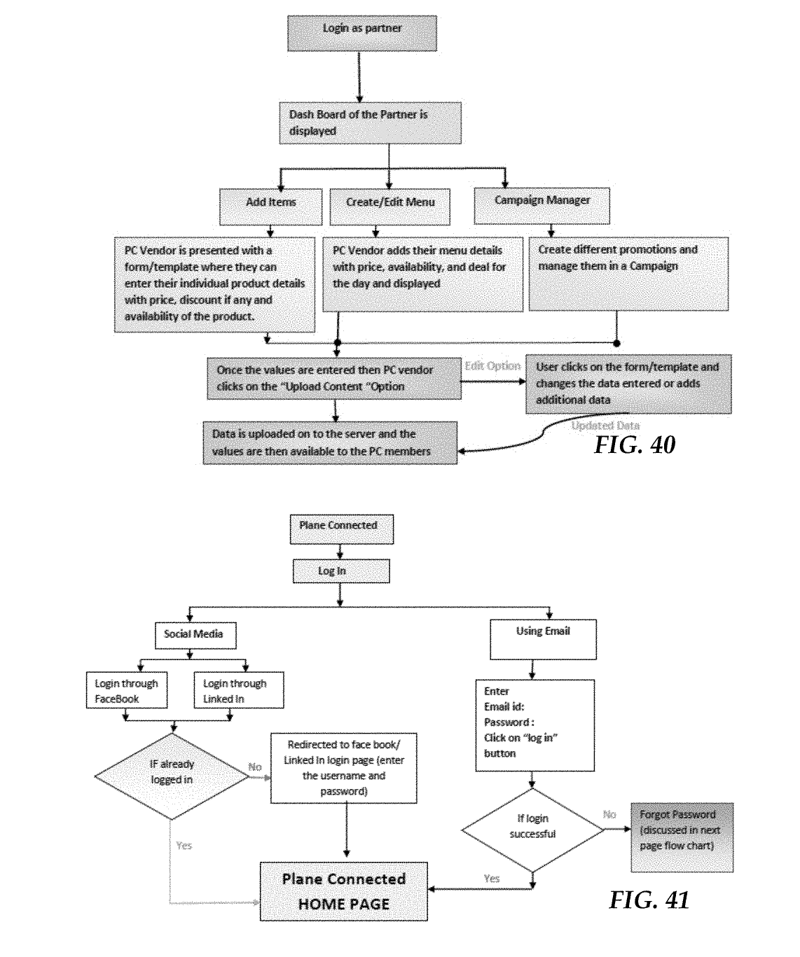

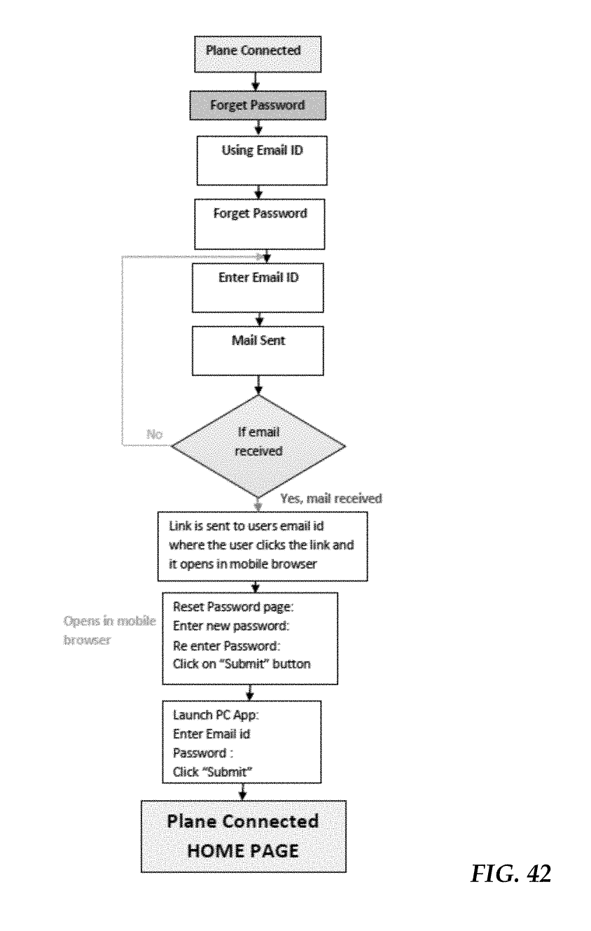

FIG. 31 shows how a purchase transaction may occur within the systems of the present disclosure and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 31 are included in this paragraph to the full extent as though expressly here written.

FIG. 30 illustrates the Plane Relocating features of the present disclosure for optimizing the situation of a passenger planning to relocate from another city to the destination city of a particular flight and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 30 are included in this paragraph to the full extent as though expressly here written.

FIGS. 33 and 34 show the Plane Single functions of the present disclosure whereby a user may connect with a dating or matching service, such as Match.com, for example, and use that system while on the airplane and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIGS. 33 and 34 are included in this paragraph to the full extent as though expressly here written.

FIG. 35 illustrates the Plane Sports features of the present disclosure whereby sports fans may identify particular sporting teams and receive particular benefits relating to such sporting teams, and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 33 are included in this paragraph to the full extent as though expressly here written.

FIG. 36 illustrates the Plane Tired function of the system of the present disclosure whereby the system turns off to provide no continuing function and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 36 are included in this paragraph to the full extent as though expressly here written.

FIG. 37 illustrates how a use may login to the system using an email connection and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 37 are included in this paragraph to the full extent as though expressly here written.

FIG. 38 illustrates the functions of the system of the present perfect in disclosure provides in the event that the use your desires to import contacts from LinkedIn or another source and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 38 are included in this paragraph to the full extent as though expressly here written.

FIG. 39 illustrates the sign-up functions of the system of the present disclosure and how are user may sign up using social media or email or other app locations for becoming a user of the presently disclosed method and system, and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 39 are included in this paragraph to the full extent as though expressly here written.

FIG. 40 illustrates the functions of the system of the present disclosure provides for enabling a vendor to participate or present to a purchaser or user the functions and benefits and features of the present system, and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 40 are included in this paragraph to the full extent as though expressly here written.

FIG. 41 shows how the system of the present disclosure use social media for the purpose of establishing an advertising campaign or otherwise benefiting the user and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 41 are included in this paragraph to the full extent as though expressly here written.

FIG. 42 illustrates the functions of the system of the present disclosure provides in the event that the user forgets his password and further details the associated features and functions of the disclosed subject matter to illustrate the novel steps and instructions that an embodiment may perform for communicating and transacting betwefficiency of time spent traveling. Exemplary electronic devices and computer processors and networks for performing the functions of the present disclosure appear herein at FIGS. 3 through 6. The features and steps appearing in FIG. 42 are included in this paragraph to the full extent as though expressly here written.

All references, including publications, patent applications, and patents, cited herein are hereby incorporated by reference to the same extent as if each reference were individually and specifically indicated to be incorporated by reference and were set forth in its entirety herein.

The methods, systems, process flows and logic of disclosed subject matter associated with a computer readable medium may be described in the general context of computer-executable instructions, such as, for example, program modules, which may be executed by a computer. Generally, program modules may include routines, programs, objects, components, data structures, etc. that perform particular tasks or implement particular abstract data types. The disclosed subject matter may also be practiced in distributed computing environments wherein tasks are performed by remote processing devices that are linked through a communications network. In a distributed computing environment, program modules may be located in local and/or remote computer storage media including memory storage devices.

The detailed description set forth herein in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein, but is to be accorded the widest scope consistent with the principles and novel features disclosed herein. It is contemplated that additional embodiments are within the spirit and true scope of the disclosed subject matter.

1. A method of controlling a passenger commercial transaction and service system that includes a cabin file server having a plurality of interfaces to communications devices and passenger-controlled components of the passenger commercial transaction and service system, comprising the steps of:
providing a closed loop system for interacting between a file server and a plurality of individual controlled communication devices wherein users of said closed loop system may interact with said closed loop system for identify at least a first individual scheduled presently or in the future to travel via a carrier vehicle;
presenting users of said closed loop system data communication instructions for directing said closed loop system to transmit gift item credits to said first individual scheduled presently or in the future to travel;
upon travelling on said commercial carrier providing said individuals instructions for operating said individual controlled communication devices for transmitting a passenger transaction from said individual controlled communication devices of said first individual to a server within a cabin of said carrier vehicle; translating the passenger transaction into identifying instruction for identifying said first individual as present within said cabin of said carrier vehicle;
permitting a second individual to direct a gift item request to said first individual;
generating a database query in response to the gift item request in the cabin file server;
accessing a database containing data regarding resources of the passenger entertainment system with a database server;
generating a response to the database query with the data from the database; and
dispatching appropriate resources defined in the response to the database query to service the passenger transaction and supply to the first individual a gift item corresponding to said gift item request.

2. The method of claim 1, wherein said second individual selects from a menu and then proceeds to make a credit payment towards the first individual in the system by crediting an electronic wallet associated with said first individual as a credit balance for the amount that the second individual transacted;
if the order for the surprise gift fails, said closed loop system will show a relevant reason to said first or second individual, as appropriate, and provide an option to retry;
said credit can be used at any time with places associated through said closed loop system.

3. The method of claim 1, wherein said credit balance applies to a balance stored on a server connected with the cabin of said carrier vehicle, whereby said first individual may apply a portion of said credit balance to one or more menu items for purchase, and upon using said credit balance for purchasing a menu item, an in-flight attendant may present said purchased menu item to said first individual.

4. The method of claim 1, further comprising the step of providing said closed loop system on a carrier vehicle from the group consisting of a commercial air flight, a commercial train, a commercial multi-passenger automobile or bus, a commercial ocean liner, a commercial river cruiser, a commercial spacecraft, a commercial funicular, a private multi-passenger air flight, a private multi-passenger train, a private multi-passenger ocean liner, a private multi-passenger river cruiser, and a private multi-passenger spacecraft.

5. The method of claim 1, wherein said credit balance applies to a balance stored on a networked information system associated with said carrier vehicle for permitting said first individual to purchase an item or service at the destination location after departing said carrier vehicle.

6. The method of claim 1, wherein said closed loop system further performs the steps of generating data analytics information for capturing customer behavior information across a plurality of first individuals and generating predictive purchase statistics and profile information across a plurality of first individuals scheduled presently or in the future to travel via a carrier vehicle.

7. The method of claim 1, wherein said closed loop system further performs the steps of providing volunteer-based information for a plurality of first individuals for permitting said first individuals to opt into communication networks and affinity groups based on the geographic positioning system data associated with their being scheduled presently or in the future to travel via a carrier vehicle.

8. A system for controlling a passenger commercial transaction and service system, including a cabin file server with one or more components for having a plurality of interfaces to communications devices and passenger-controlled components of the passenger commercial transaction and service system, comprising:
a database in the cabin file server for providing a closed loop system for interacting between a file server and a plurality of individual controlled communication devices wherein users of said closed loop system may interact with said closed loop system for identify at least a first individual scheduled presently or in the future to travel via a carrier vehicle;
a data file server for presenting users of said closed loop system data communication instructions for directing said closed loop system to transmit gift item credits to said first individual scheduled presently or in the future to travel;
said cabin file server providing instruction for providing said individuals instructions for operating said individual controlled communication devices for transmitting a passenger transaction from said individual controlled communication devices of said first individual to a server within a cabin of said carrier vehicle; translating the passenger transaction into identifying instruction for identifying said first individual as present within said cabin of said carrier vehicle;
instructions associated with said database server and a network, said network communicating with a plurality of individually-controlled components for permitting a second individual to direct a gift item request to said first individual
instructions for generating a database query in response to the gift item request in the cabin file server;
instructions for accessing a database containing data regarding resources of the passenger entertainment system with a database server;
instructions for generating a response to the database query with the data from the database; and
processing instructions on said database server for dispatching appropriate resources defined in the response to the database query to service the passenger transaction and supply to the first individual a gift item corresponding to said gift item request.

9. The system of claim 8, further providing instructions on said database server and said individual-controlled components wherein said second individual selects from a menu and then proceeds to make a credit payment towards the first individual in the system by crediting an electronic wallet associated with said first individual as a credit balance for the amount that the second individual transacted;
if the order for the surprise gift fails, said closed loop system will show a relevant reason to said first or second individual, as appropriate, and provide an option to retry;
said credit can be used at any time with places associated through said closed loop system.

10. The system of claim 8, further providing instructions on said database server and said individual-controlled components wherein said credit balance applies to a balance stored on a server connected with the cabin of said carrier vehicle, whereby said first individual may apply a portion of said credit balance to one or more menu items for purchase, and upon using said credit balance for purchasing a menu item, an in-flight attendant may present said purchased menu item to said first individual.

11. The system of claim 8, further providing said closed loop system on a carrier vehicle from the group consisting of a commercial air flight, a commercial train, a commercial multi-passenger automobile or bus, a commercial ocean liner, a commercial river cruiser, a commercial spacecraft, a commercial funicular, a private multi-passenger air flight, a private multi-passenger train, a private multi-passenger ocean liner, a private multi-passenger river cruiser, and a private multi-passenger spacecraft.

12. The system of claim 8, further providing instructions on said database server and said individual-controlled components wherein said credit balance applies to a balance stored on a networked information system associated with said carrier vehicle for permitting said first individual to purchase an item or service at the destination location after departing said carrier vehicle.

13. The system of claim 8, further providing instructions on said database server and said individual-controlled components wherein said closed loop system further performs the steps of generating data analytics information for capturing customer behavior information across a plurality of first individuals and generating predictive purchase statistics and profile information across a plurality of first individuals scheduled presently or in the future to travel via a carrier vehicle.

14. The system of claim 8, further providing instructions on said database server and said individual-controlled components wherein said closed loop system further performs the steps of providing volunteer-based information for a plurality of first individuals for permitting said first individuals to opt into communication networks and affinity groups based on the geographic positioning system data associated with their being scheduled presently or in the future to travel via a carrier vehicle.

15. A carrier vehicle comprising a system for controlling a passenger commercial transaction and service system, including a cabin file server with one or more components for having a plurality of interfaces to communications devices and passenger-controlled components of the passenger commercial transaction and service system, said carrier vehicle comprising:
a carrier vehicle providing a closed loop system, said carrier vehicle comprises a carrier vehicle from the group consisting of a commercial air flight, a commercial train, a commercial multi-passenger automobile or bus, a commercial ocean liner, a commercial river cruiser, a commercial spacecraft, a commercial funicular, a private multi-passenger air flight, a private multi-passenger train, a private multi-passenger ocean liner, a private multi-passenger river cruiser, and a private multi-passenger spacecraft;
a system for controlling a passenger commercial transaction and service system, comprising:
a database in the cabin file server for providing a closed loop system for interacting between a file server and a plurality of individual controlled communication devices wherein users of said closed loop system may interact with said closed loop system for identify at least a first individual scheduled presently or in the future to travel via a carrier vehicle;
a data file server for presenting users of said closed loop system data communication instructions for directing said closed loop system to transmit gift item credits to said first individual scheduled presently or in the future to travel;
said cabin file server providing instruction for providing said individuals instructions for operating said individual controlled communication devices for transmitting a passenger transaction from said individual controlled communication devices of said first individual to a server within a cabin of said carrier vehicle; translating the passenger transaction into identifying instruction for identifying said first individual as present within said cabin of said carrier vehicle;
instructions associated with said database server and a network, said network communicating with a plurality of individually-controlled components for permitting a second individual to direct a gift item request to said first individual;
instructions for generating a database query in response to the gift item request in the cabin file server;
instructions for accessing a database containing data regarding resources of the passenger entertainment system with a database server;
instructions for generating a response to the database query with the data from the database; and
processing instructions on said database server for dispatching appropriate resources defined in the response to the database query to service the passenger transaction and supply to the first individual a gift item corresponding to said gift item request.

16. The carrier vehicle of claim 15, wherein said system for controlling a passenger commercial transaction and service system further provides instructions on said database server and said individual-controlled components wherein said second individual selects from a menu and then proceeds to make a credit payment towards the first individual in the system by crediting an electronic wallet associated with said first individual as a credit balance for the amount that the second individual transacted;
if the order for the surprise gift fails, said closed loop system will show a relevant reason to said first or second individual, as appropriate, and provide an option to retry;
said credit can be used at any time with places associated through said closed loop system.

17. The carrier vehicle of claim 15, wherein said system for controlling a passenger commercial transaction and service system further provides instructions on said database server and said individual-controlled components wherein said credit balance applies to a balance stored on a server connected with the cabin of said carrier vehicle, whereby said first individual may apply a portion of said credit balance to one or more menu items for purchase, and upon using said credit balance for purchasing a menu item, an in-flight attendant may present said purchased menu item to said first individual.

18. The carrier vehicle of claim 15, wherein said system for controlling a passenger commercial transaction and service system further provides instructions on said database server and said individual-controlled components wherein said credit balance applies to a balance stored on a networked information system associated with said carrier vehicle for permitting said first individual to purchase an item or service at the destination location after departing said carrier vehicle.

19. The carrier vehicle of claim 15, wherein said system for controlling a passenger commercial transaction and service system further provides instructions on said database server and said individual-controlled components wherein said closed loop system further performs the steps of generating data analytics information for capturing customer behavior information across a plurality of first individuals and generating predictive purchase statistics and profile information across a plurality of first individuals scheduled presently or in the future to travel via a carrier vehicle.

20. The carrier vehicle of claim 15, wherein said system for controlling a passenger commercial transaction and service system further provides instructions on said database server and said individual-controlled components wherein said closed loop system further performs the steps of providing volunteer-based information for a plurality of first individuals for permitting said first individuals to opt into communication networks and affinity groups based on the geographic positioning system data associated with their being scheduled presently or in the future to travel via a carrier vehicle.
